(19) United States
(12) Patent Application Publication
(10) Pub. No.: US 2012/0246741 A1
(43) Pub. Date: Sep. 27, 2012

(54) Universal Medical Records Processing System

(75) Inventors: Michael Klotz, Pacific Palisades, CA (US); Ronald H. Makita, Sunland, CA (US)

(73) Assignee: Health Data Vision, Inc.

(21) Appl. No.: 13/474,524

(22) Filed: May 17, 2012

Related U.S. Application Data
(63) Continuation-in-part of application No. 13/053,502, filed on Mar. 22, 2011.
(60) Provisional application No. 61/487,189, filed on May 17, 2011.

(51) Int. Cl. G06F 21/24; G06F 15/16

(52) U.S. Cl. 726/28; 709/217

(57) ABSTRACT

A medical records collection and processing system to provide an efficient, scalable, and accurate process for collecting, analyzing, and delivering medical records or analysis of medical records to a client. The collection system allows for user configured projects. The processing system allows the user to securely deliver the requested documents to the collection system or any other system electronically without compromising security and efficiency. With the Universal Medical Records Processing System, a format, system and platform-independent, almost unlimited reach for the request and processing of responses for medical records is accomplished. The invention dramatically increases the efficiency and security of medical records processing while dramatically lowering costs.

### CROSS-REFERENCE TO RELATED APPLICATION

This patent application is a continuation-in-part application of U.S. patent application Ser. No. 13/053,502 filed Mar. 22, 2011, entitled “Medical Record Collection System,” and this patent application claims the benefit of U.S. Provisional Patent Application No. 61/487,189, entitled “Medical Records Processing System,” filed May 17, 2011, which applications are incorporated in their entirety here by this reference.

### BACKGROUND OF THE INVENTION

1. Technical Field

This invention relates to an internet based system for locating, collecting, and analyzing medical records and delivering these records and the analysis results of the medical records to clients and other organizations.

2. Background Art

Each year hundreds of health insurance companies, accreditation and government agencies as well as pharmaceutical companies, medical services companies, and universities need to audit providers and medical records for compliance, billing, research, and quality, which amounts to millions of healthcare records that need to be securely accessed, reviewed, analyzed and reported on. These studies and audits are key components of ongoing healthcare quality and research.

The current ways of accomplishing these critical needs are very cost-intensive and ineffective, having an adverse impact on both top and bottom line. The processes of many of the companies providing these services have remained unchanged for many years and have not kept up with the changing technologies in the healthcare industry. They often require constant training and re-training of staff that changes from project to project, and require qualified record reviewers to be in close vicinity of the providers and facilities being audited. Systems for most companies providing these services do not have provisions for providing quality and completeness checks at each step of the process, which compromises results and slows the process.

Thus, there is a need for a medical records collection and analysis system that has a process-oriented, end-to-end configurable workflow with detailed status tracking and audit trails and a high level of automation.

### BRIEF SUMMARY OF INVENTION

The present invention is directed to a medical records collection system that is a fully integrated and highly automated process solution for the collection and delivery of results of an analysis of a desired paper medical record. It implements a flexible workflow and a number of optimized functionality aiding the performance of steps in the process. The unique implementation allows for specialized job roles, using highly qualified personnel only where their expertise is truly needed, leaving other tasks to non-medical personnel or to automation.

It utilizes a web-based, secured application with role based security, allowing provisioning users for certain activities, and for clients to access a client portal through a client application, which provides reporting, review, feedback and download features. The system implements a superior process and specialized tools which address the needs for volume, speed, quality and visibility for clients' review.

The system implements years of best practices and a highly optimized process that breaks down inefficiently performed tasks into more granular steps with defined main process flows and numerous exceptions and alternative paths. This makes the process very repeatable, scalable and auditable. Manual steps, to the extent required, are aided and made very efficient through the support of functionality in the system. This is especially important as quality and auditability of the quality of the analysis has not been achieved in a consistent fashion in the industry, especially at high volumes.

The system, due to the process approach taken, has comprehensive meta-data, spanning the life of a process instance, which enables detailed status reporting, intelligent routing, elimination of many common errors, speed, and efficiency. The result is superior quality, the ability to audit the quality, and a significant cost-advantage due to automation.

The system eliminates errors due to the ability to have a meta-data driven process, allowing the system to ‘lock down’ many variables and causes for errors or omissions in the process, for example, the association of medical records with the appropriate patient and provider information.

The system also implements secondary pursuits of missing records, which aids personnel in the scheduling function to locate medical records at locations not previously identified.

The system also provides for an efficient and secure method of transmitting medical records to the medical records database for delivery to clients by uploading files from the provider's computer and downloading to the repository, or by virtually printing files from the provider's computer directly to the repository.

### BRIEF DESCRIPTION OF THE DRAWINGS

FIG. 1 is a flow diagram an embodiment of the overall process of the medical record collection system;

FIGS. 2A-2C is a flow diagram of another embodiment of the overall process of the medical record collection system;

FIG. 3 is a screen shot of the project configuration window;

FIG. 4 is a screen shot of a window displaying project measures;

FIG. 5 is a screen shot of a window displaying a provider site list;

FIG. 6 is a screen shot of a window displaying detailed information of a provider;

FIG. 7 is a screen shot of a window displaying a geo-coded map;

FIG. 8 shows the capture screen used by Field Technicians when scanning medical records;

FIG. 9 shows an example of a chart cover sheet with a checklist;

FIGS. 10A and 10B are screen shots of a window displaying a triage detail;

FIG. 11 is a flow diagram of the overread process;

FIG. 12 is a partial screen shot of a window displaying the overread screen;

FIGS. 13A-13E are screen shots of features from the client portal;

FIG. 14 is a server topology diagram of the system architecture;

FIG. 15 is a conceptual diagram of system components of an embodiment of the system architecture;

FIG. 16 is a flow diagram of another embodiment of the system architecture;

FIGS. 17A-17B show a flow diagram of the process of retrieving records;

FIGS. 18A-18C show a system flow diagram for chart processing;

FIG. 19 is a diagram of an overview of an embodiment of a medical records processing systems for fax and mail processing

FIG. 20 is a diagram of an overview of another embodiment of a medical records processing system for new, paperless processing methods;

FIG. 21 is a screenshot of an embodiment of the client portal that facilitates secure uploads via the web for the processing system;

FIG. 22 is a screenshot of a window of a typical printer selection in a Windows-based system displaying the print wizard printing option;

FIG. 23 is a screenshot of the print wizard displaying request project and member options of the records to print;

FIG. 24 is a screenshot of the print wizard displaying a checklist of documents the user has selected to virtually print;

FIG. 25 is a screenshot of the print wizard displaying the progress of the secure transmission (virtual print job);

FIG. 26 is a screenshot of the print wizard displaying the completion confirmation of the secure transmission (virtual print job);

FIG. 27 is a diagram of the relationship of the medical records collection system modules, including components used by the medical records processing system; and

FIG. 28 is a sequence diagram of the steps involved in the processing system.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for operating the invention in connection with the illustrated embodiments. However, it is to be understood that the same or equivalent functions and sequences may be accomplished by different embodiments that are also intended to be encompassed within the spirit and scope of the invention.

The medical records collection system provides an efficient and accurate system for collecting, analyzing, and delivering medical records or analysis of medical records to a client or client system. The system utilizes the Internet to allow employees or clients to configure their own projects to be performed and delivered according to the client's predetermined standards, or project requirements. It improves efficiency by standardizing, mapping, and geo-coding provider information, provides organization by utilizing a unique scheduling system for requesting and retrieving records via means such as fax, mail, portal, or electronic medical record. It economizes record retrieval by providing the option of using field technicians, and improves accuracy utilizing the triage system to check for quality of the records retrieved. It provides tools for analysis by qualified staff members (typically clinicians) through abstraction of the records, maintains accuracy of the abstraction through an overread process, and delivers highly accurate results that can be reviewed by and delivered to clients according to the client's specification.

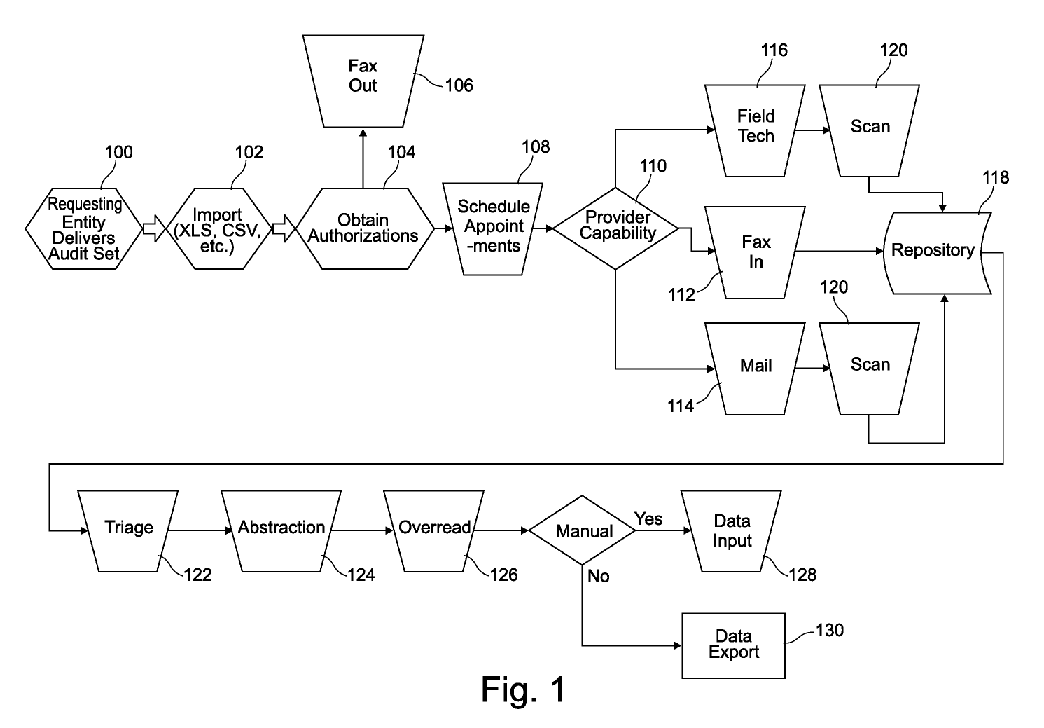

As shown in FIG. 1, in one embodiment, a request is made by a requester, for example, when a client or external system delivers an audit set 100 to retrieve certain medical records. This is imported 102 into the system, which executes the process for submitting and retrieving the medical records requested. Once imported, the proper authorization to collect the records is obtained 104. The authorization request is usually in the form of an automatically generated fax 106. Once the authorization is obtained an appointment is scheduled 108 with the provider, which possesses the medical records of interest, to obtain the proper records. A determination is made as to the provider's capabilities or preferences for delivering the records 110. For example, the provider may fax 112, mail 114, or upload the records through a client portal. Alternatively, the provider may simply make the records available for a field technician to scan on-site 116. Once the record is retrieved, it is securely deposited into the repository 118 of the system. In some embodiments, the record may be scanned 120 and deposited into the central records repository 118 at the data center of the system.

Once in the repository, the record undergoes a triage step 122 in which the record is assessed for legibility and completeness. The record is then sent to an abstractor 124 for abstraction (i.e. analysis). For quality control of the analysis work, the abstraction results may be selectively overread 126. The new data may be inputted 128 into the system prior to being exported to the client 130.

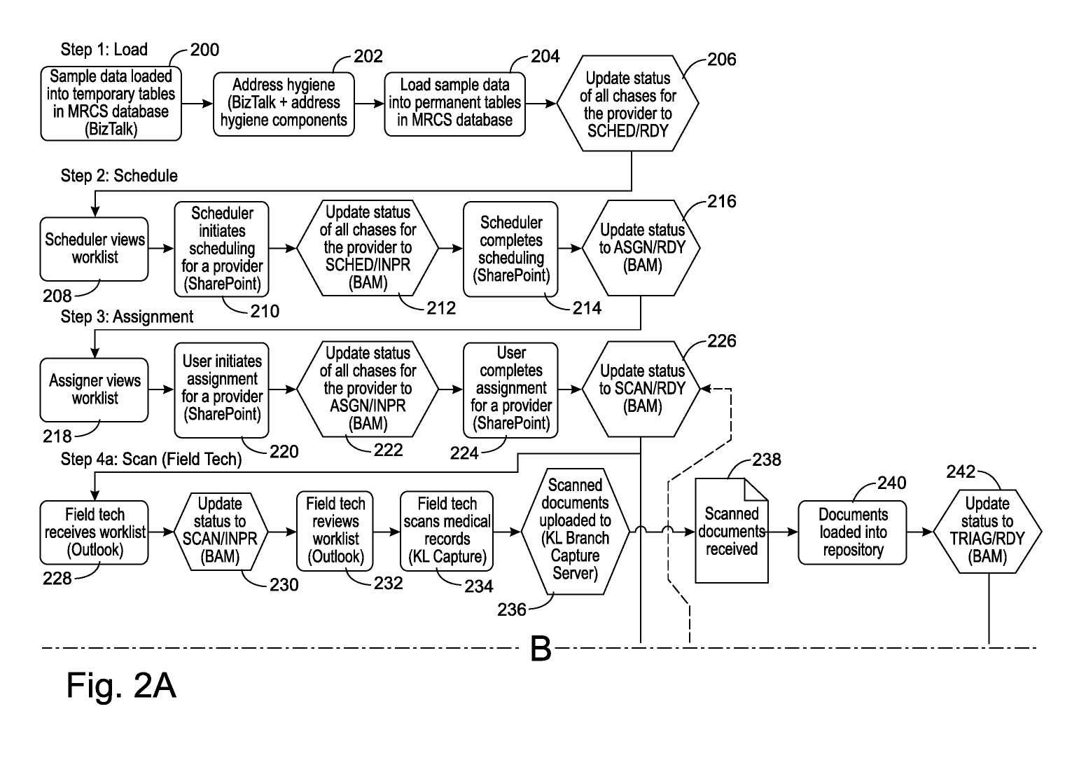

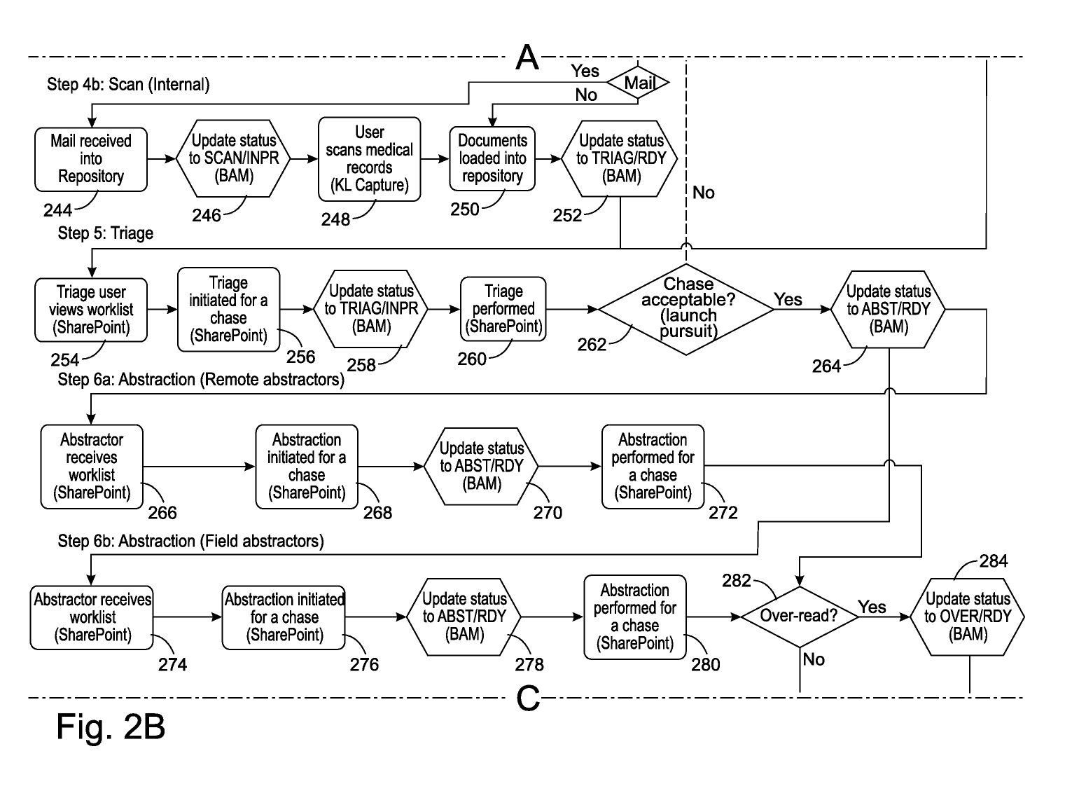

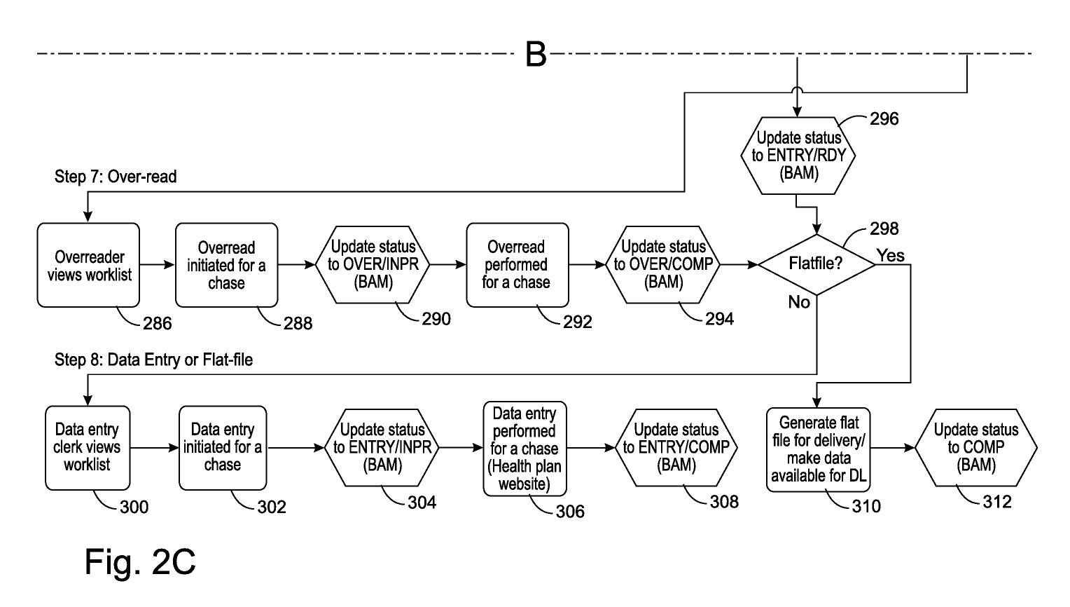

FIGS. 2A-2C show a flow diagram of examples of specific steps involved in various embodiments of the present invention.

Project Configuration

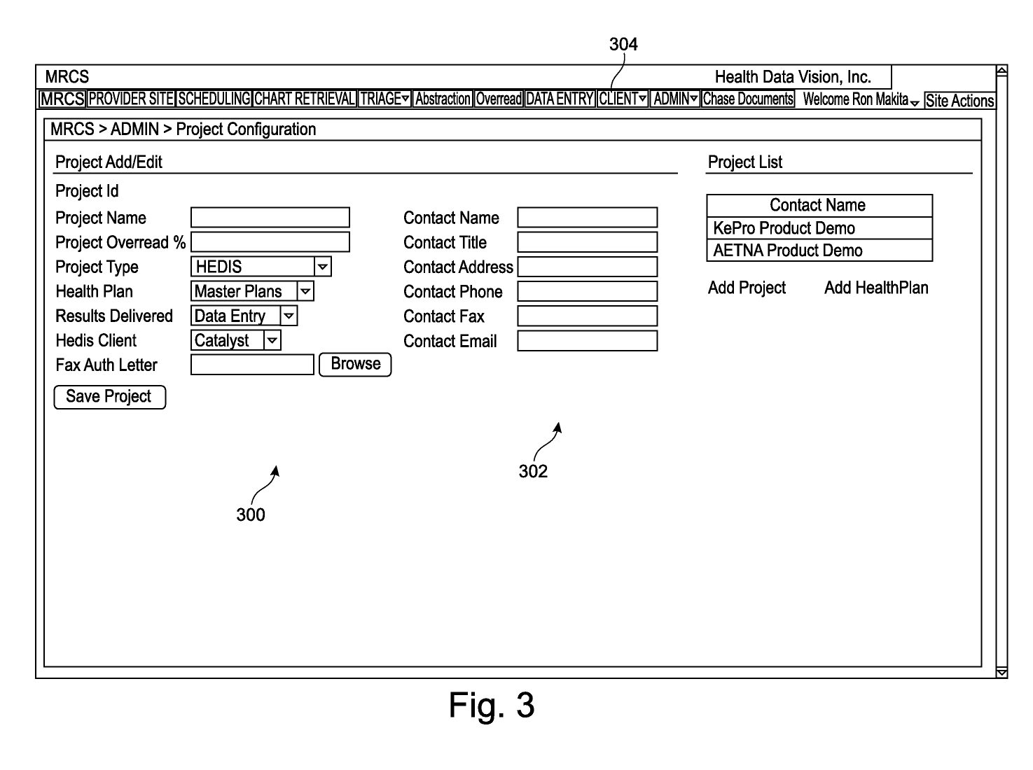

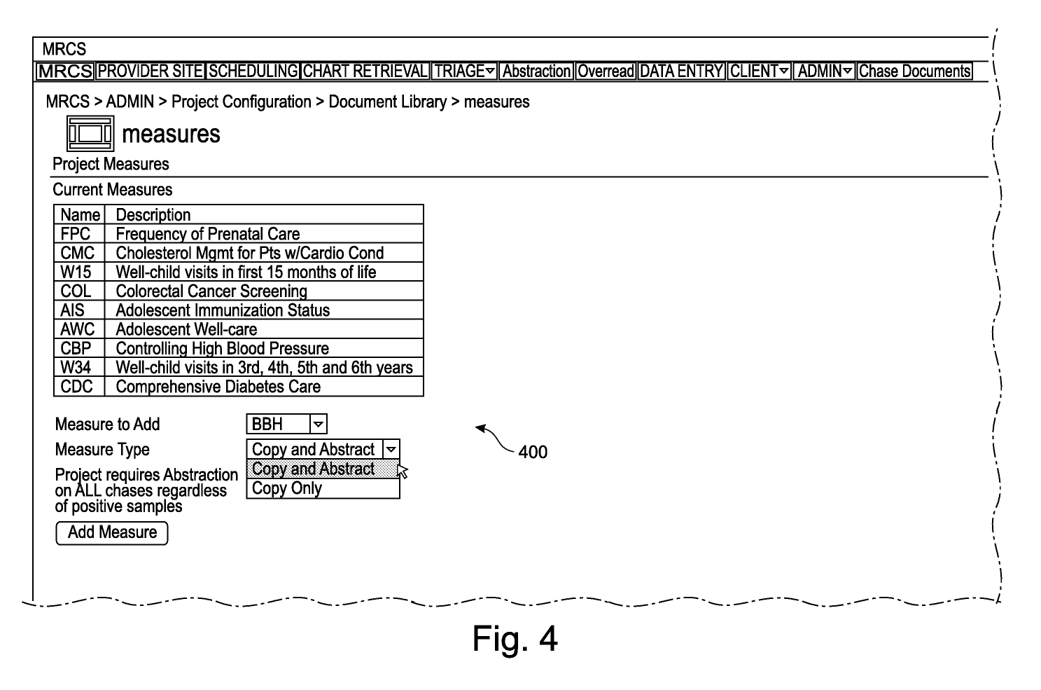

Clients and projects are set up and configurable in the system so that a client can choose the level of service for a particular project and select various processing preferences, as shown in FIGS. 3 and 4. The project configuration window provides appropriate fields 300 to configure the project as well as contact information 302. In other words, the client can choose which steps in the system the client wants the system to execute and the level of care or scrutiny with which the steps are carried out. For example, a particular client may have internal staff perform some of the process steps themselves, such as the abstraction or overread processes. The system may be configured to exclude the abstraction or overread process for this particular client. Alternatively, rather than excluding a step all together, the system may be configured, for example, so that the level of overread or the overread percentage (QA sample rate) is decreased or increased to affect the level of the quality checks for a particular project.

To configure a project, a new record is set up containing the client's identifying information, such as name, address, contact information, and the like. Additional information, such as the client's affiliation with other entities or organizations may be inputted into a client setup screen.

A client application is provided through which the client can access all pertinent project information. A client can communicate with the system using a client portal 304 that can be accessed via a web browser or different computing devices, such as a computer, laptop, netbook, phone, personal digital assistant, smart phone, BlackBerry, iPhone, tablets, and other like electronic devices that can send and receive communications through the internet, radiowaves, and the like. The client's preferences may be configured so that the system may be instructed with which actions to take or services to provide, with what level of quality to execute those actions or provide those services, and how and what to deliver to the client as the final product.

For example, as shown in FIG. 4, if the client is able to self-abstract or self-overread (i.e. perform the abstraction step or the overread step internally), configuration options 400 are available so that the project may be configured as “copy only” where health records or medical records are collected and delivered only, leaving the abstraction and overread steps for the client to perform outside of the system. Alternatively, the client's project may be configured for “Copy and Abstract” if the client wants the system to review the records and conduct an analysis.

If the client selects the “Copy and Abstract” configuration, the client can further select the quality of overread. A percentage between 0% and 100% may be entered, depending on the client's requirements. This percentage becomes the percentage of each abstractor's records that get overread for quality by senior abstractors.

The delivery options of the final product can also be configured. Options are presented to the client for delivering either a flat file of the results or data entry to client's application. The flat file delivery may be an electronic copy of any results obtained analyzing charts obtained from the providers and/or the results of the abstraction of those charts. Data entry allows a staff member to view collected data on a display screen and input the requested information into the system for further processing. The client can then review the inputted information by accessing the client portal 304, even from a remote location using any electronic device that is capable of transmitting and/or receiving communications through a landline or wirelessly. For example, the client can review the inputted information by accessing the client portal 304 securely through a Web browser through the Internet.

An authorization letter from the client may also be attached to the project. When faxing out medical record requests to providers for the project, this letter is automatically faxed with the request.

The project can also be configured for a specific measure. A measure is the medical condition or any other information to be queried by the client for a specific purpose, such as wellness, lifestyle, health, clinical, medical, pharmaceutical information, and the like. For example, the measure of a particular project may be a specific patient's blood pressure, cholesterol level, blood-glucose level, lab results, X-rays, scans, and the like. It may even be more comprehensive such as the medical condition of a specific patient, such as diabetes, cancer, or atherosclerosis.

Once the project has been configured, the system can dispatch its staff members to perform the necessary function, such as collecting the proper records, analyzing the records, and delivering the analysis to the client.

Data Load

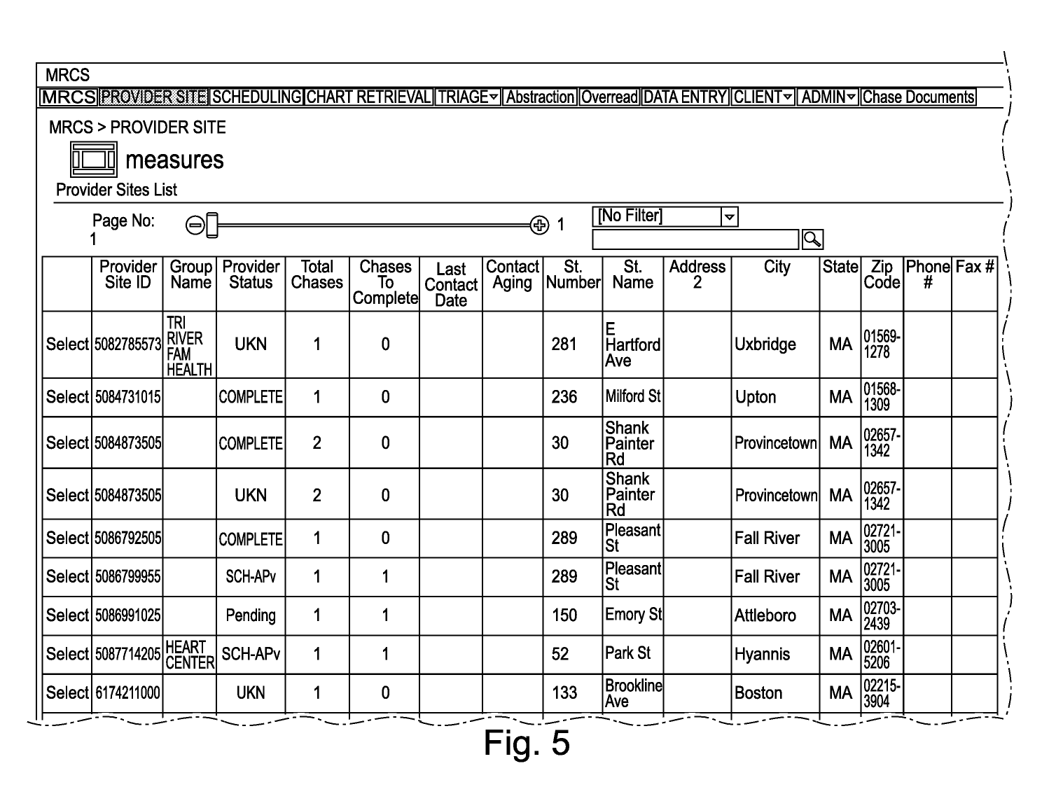

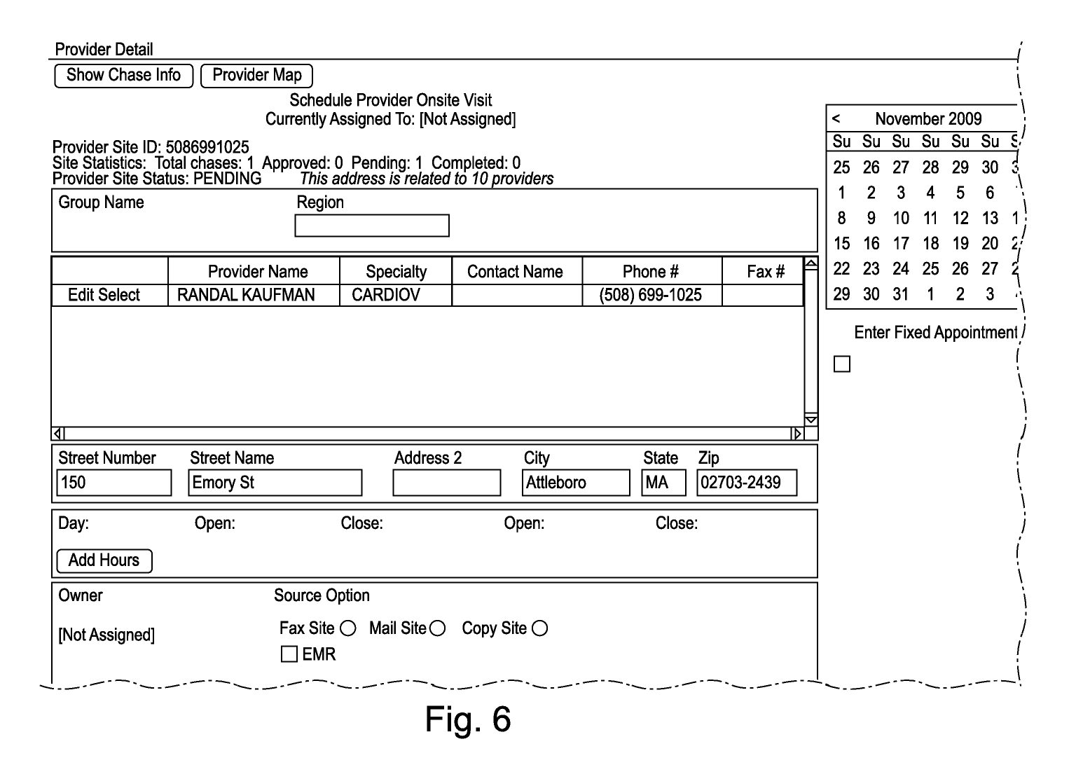

As shown in more detail in FIGS. 2A-2C, to facilitate the efficient dispatching of team members to collect the required information from the providers, for example, providers' addresses are collected and inputted into the system 200. This information may be checked, standardized, and organized. This process is referred to as address hygiene or address scrubbing 202, which may include geo-coding. For example, names and addresses may be edited to comply with the established formats for uniformity. Once the information is scrubbed, it may be placed into a permanent database 204, and the status of request or chase for the provider is updated as being ready for scheduling (SCHED/RDY) 206. Member (e.g. patient) and provider information provided by the client is loaded into the system which organizes and displays the provider information in a sortable table as shown in FIG. 5. The information may be sorted according to a variety of headers. Any entry can be clicked on to retrieve information on a provider as shown in FIG. 6.

Often times clients provide the provider's address 700. The information provided by the clients may be either in inconsistent formats, or incorrect or non-existent addresses. This causes delays in the scheduling process and possibly results in incomplete record collection.

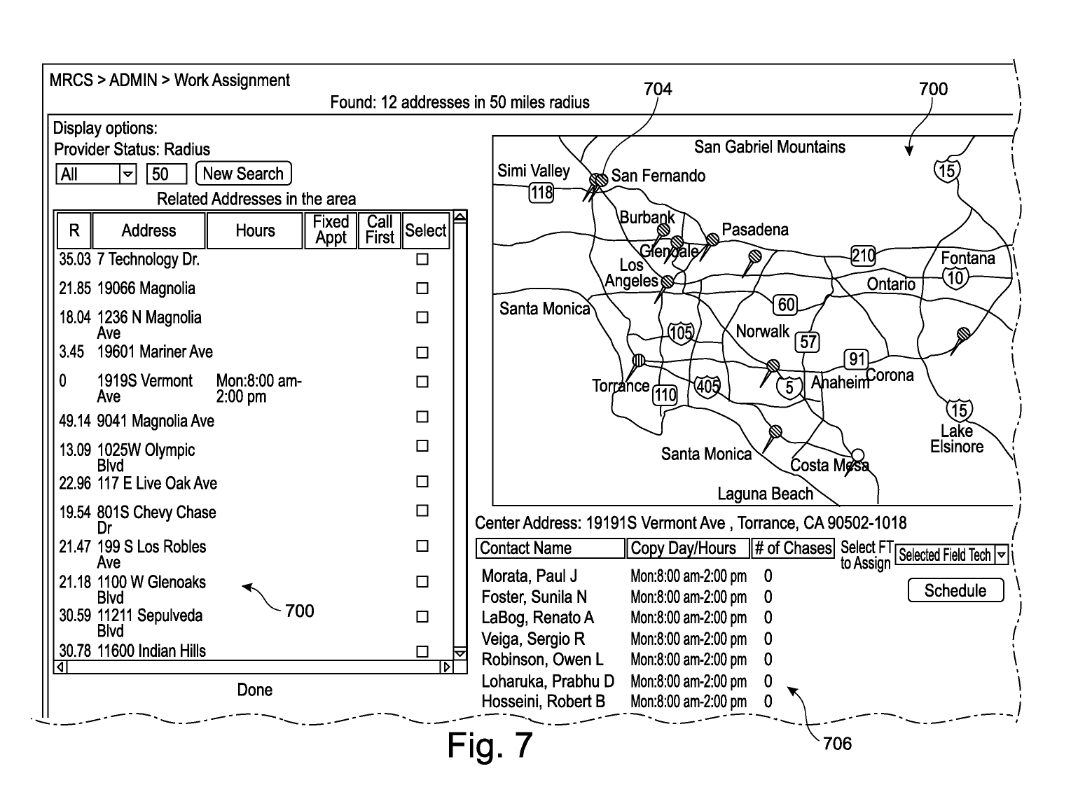

Therefore, once the information is collected and inputted into the system, the information may be verified, standardized, and geo-coded which makes the downstream steps of the process much more efficient. A staff member may look up the address 700 or call the provider to ensure the address 700 is correct and up to date. The staff member may edit the address 700 so that it complies with the specific format utilized by the system. In addition, to geo-code the provider's location, the addresses are mapped on an electronic map 702 with color coding 704 indicating the status of the address for display on a monitor, screen, or other type of display device as shown in FIG. 7. The color coding 704 provides additional information to help the system run efficiently. For example, the color coding 704 may indicate that the address has been verified or still requires verification or the color coding may indicate if a field technician has been assigned to the address. The contact and copying information 706 may also be provided.

This step assures that provider locations are correctly combined so the provider receives a single consolidated request rather than multiple requests. Exception addresses that cannot be verified or that are incorrect will be researched by a scheduler to correct. If the scheduler is unable to resolve the problem, addresses may be returned to the client for correction or verification.

By performing the address hygiene step certain inefficiencies may be avoided such as dealing with redundant requests to the provider or sending requests to wrong providers outside of the system. Exception addresses are often times not identified until late in the project, therefore, this process allows for early detection and correction.

Once the provider information is edited and standardized, schedulers can efficiently schedule the collection and retrieval of the records required for the completion of the requested project.

Scheduling

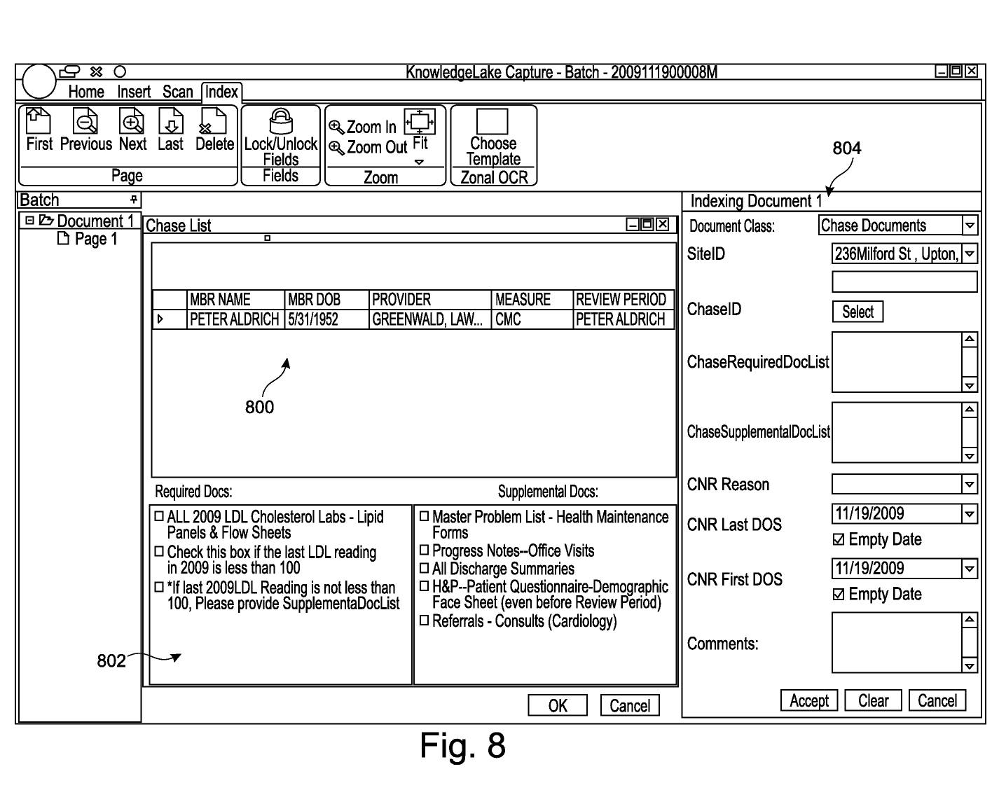

Schedulers manage the submission of the request for a record, referred to as a chase, and the retrieval of the requested document. FIG. 8 shows a sample of a chase document with the provider information 800, a section for the scheduler to indicate the desired documents 802, and section for indexing 804. To perform efficient submission and retrieval of the desired document, the scheduler contacts the provider, submits the request, monitors the status of the request, and coordinates the retrieval of the records.

Schedulers may be assigned specific providers to contact and to submit record requests. Schedulers may be assigned to specific providers based on the provider's site or location, such as the provider's state, city, area code, or zip code. This geographical assignment also facilitates efficient dispatch of field technicians. Other characteristics may be used to assign providers to schedulers, such as affiliation of the provider, specializations of the provider, and the like.

The scheduler's station is equipped with a computing device to view his or her worklist 208, such as a computer executing a specific program application to contact and monitor the providers. Since specific schedulers are responsible for specific providers or providers located at a specific site or area, when a scheduler signs in or logs in to the systems, the scheduler's default screen will be to see only a summary of their assigned providers. For example, the summary may display the provider's status and last contact date/contact aging.

The provider detail comprises a list all providers at the assigned or designated site with a record request, phone, fax, and address information. The scheduler can also view record request (chase) details and can view the providers' location on a map. Provider geo-coding (color coded map) also allows schedulers visibility of other nearby facilities on the map, which allows them to efficiently work on sites that are close to each other.

The scheduler may also be provided the option of viewing all providers in the system or searching for specific providers or groups utilizing multiple search and filtering options, such as keyword searches, alphabetical listing by name of provider, listing based on name of patient being queried, specializations, and the like.

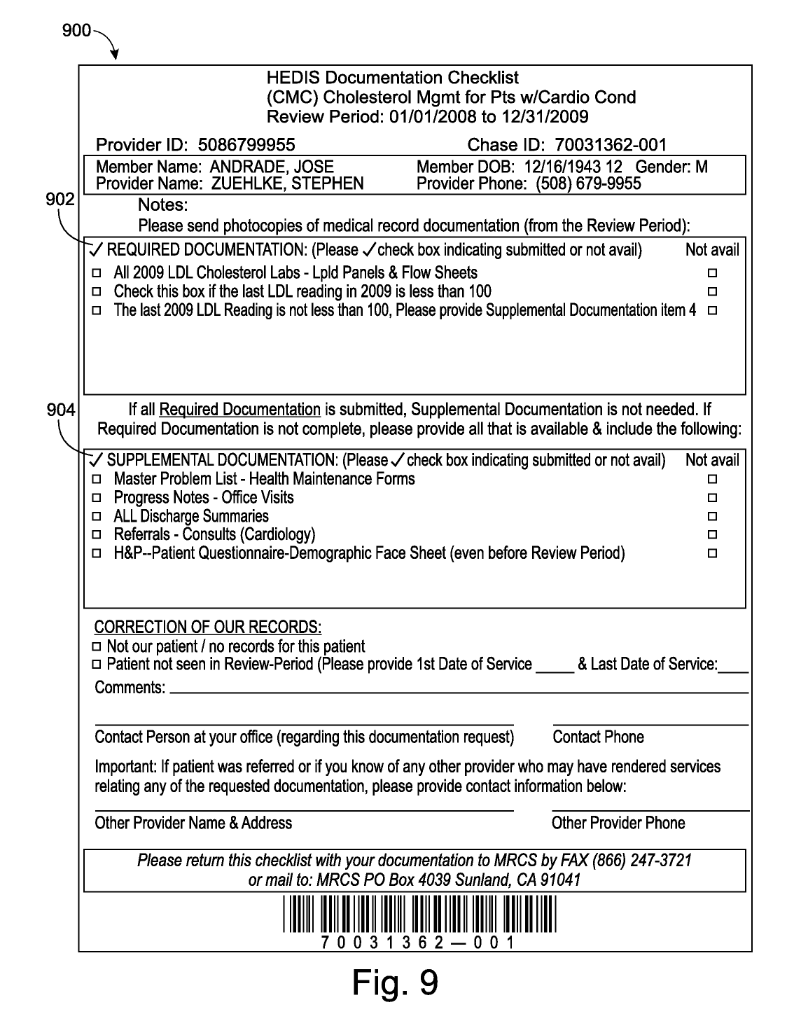

The scheduler initiates the scheduling process 210 and updates the status of chases for the provider as being ready in progress (SCHED/INPR) 212. The scheduler has options to configure the record request package by selecting a retrieval type (fax, mail, copy, e-mail, Internet) which will automatically choose the proper documents to send to the provider to effectuate the retrieval by the selected mode of delivery. Individual record requests that include specific documentation required for review may be sent by any mode of communication, such as fax, mail, e-mail, and/or Internet. These request documents 900 include checklists (as shown in FIG. 9) for retrieving complete records for each member or patient. Schedulers have visibility of the date/time for each request and all contacts with the provider to monitor, update, or change any request. Schedulers also have visibility of very detailed status codes by provider location and individual chase, depending on what stage of the process the project is currently in.

In one example, schedulers contact providers and fax out requests for medical records. The fax includes a customizable fax cover sheet explaining the request, its purposes, etc. (, a statement that authorizes system to collect records on behalf of the client, and appropriate language in compliance with the Health Insurance Portability and Accountability Act (HIPAA), a consolidated listing of the members being requested, and individual record requests for each member. The individual record requests 900 contain measure-specific checklists 902, 904 of documents required to fulfill the measure.

For documents that are expected to be scanned by field technicians, the scheduler has the option of excluding the individual member requests. Each time a request is sent to a provider, a record of the request is created in the contact history and stored as a comment with the date, time and requested members.

Schedulers arrange for record retrieval by requesting return of the records via fax, mail, email, and/or Internet, or to schedule onsite visits by a field technician who scans the records. Once the retrieval method is determined, schedulers identify the proper contact person at the provider that is responsible for the release of the records. A contact history of each conversation and contact with the provider is recorded.

There may be cases where a provider alerts a scheduler that the information sought for a member does not exist. It may be that the member is not a patient of the provider, the member may not have been seen in the time frame of the measure, or a number of other reasons. In those cases, the scheduler may create a Certificate of No Record (CNR) for that member and categorize the CNR by reason code, which indicates the reason why the information sought for that member did not exist in the provider's files. A CNR can be viewed by the client for verification. The provider may also provide the scheduler with information that a member's record may be at another location, or that there may be multiple records for the member. Options are available to easily copy or reassign a chase to another provider (or the provider's second location).

Once the scheduler completes the scheduling 214, the status of the chase is updated as being ready for assignment (ASGN/RDY) 216. When a site is approved for the field technician scanning, the scheduler enters the date and time available for scanning or sets up an appointment for scanning by the field technician.

Assignment

All approved sites become available to assign to field technicians if determined that they will not or cannot fax, mail, or upload the requested information. An administrator or assigner views the worklist for assignment 218 and initiates an assignment 220. For example, the administrator can view addresses, days and hours for copy, and the number of records scheduled for copy. The administrator may also view a map of the location along with other nearby providers. The chase status is updated to reflect that the chase is in the process of being assigned (ASGN/INPR) 222. Once assigned, it may be sent to the field technician 228 securely via the Internet, to a dedicated field technician equipment. As one example, the task may be submitted via Outlook. Once the assignment is complete 224 the chase status may be updated as being ready for scanning (SCAN/RDY) 226.

The chase status is updated to reflect that the records for the chase or in the process of being scanned 230. The task may include the address, site information, contact information at the site, appointment time or available scanning times, a listing of the records to scan, and the individual request checklists. Mapping and routing of tasks are available so the field technician can schedule efficiently.

Field technicians can review their worklist 232 to determine the records they are supposed to retrieve. Field technicians will visit a facility during scheduled hours and scan records 234 for each individual for which information is to be collected. As records are scanned, they are securely transmitted to the central record repository 240. The records may be scanned and transmitted 236 in real time if a proper signal for transmission is available. If a signal is not available, the records are placed in queue and are transmitted when a signal becomes available. The field technician also completes the document checklist, indicating which documents were found and not found in the record or chart.

The records are submitted into the system either by the provider or the field technician. Providers may choose to fax, mail, e-mail, or utilize the Internet to deliver the requested records to the system. Field technicians can scan the medical records and transmit the records to the system electronically.

Once the records are received 238, the records are loaded and held in a central record repository 240 with their associated metadata that correctly identifies the record throughout the rest of the process. In the preferred embodiment, the received records may be received or converted to .tiff format, or other electronic or digital file format, for efficient processing; however, other formats may be used. The chase is then upated to indicate readiness for triage (TRIAG/RDY) 242.

Field technicians typically scan between 3 to 5 times faster than an onsite nurse reviewer. In addition, a nurse's capacity is limited to the provider's office hours. Also, onsite nurses are required to learn all of the review types for a project as a provider may have members for every type, not just the specialty of the reviewer. Regardless of the source of submission of the records, all records are handled in the same consistent manner to assure quality and completeness.

Field technicians are trained and tested annually, similarly to the abstractors, but are trained to scan document types instead of specific record information. When at a provider office, the field technician is armed with a document checklist for each patient or member, which details the items to scan. They typically only scan documents that are relevant to the measure which makes abstraction much more efficient.

In some embodiments, records are received by mail, fax, email, or via Internet 244. Once received, the status is updated to indicate that it is in the process of scanning 246. Mailed in records go through the same process as ones that are faxed in or electronically submitted, except that the mailed record is scanned 248 to create an electronic record, such as a .tiff file. The records are uploaded into the repository 250 and the status is updated to indicate that the records are ready to undergo triage 252.

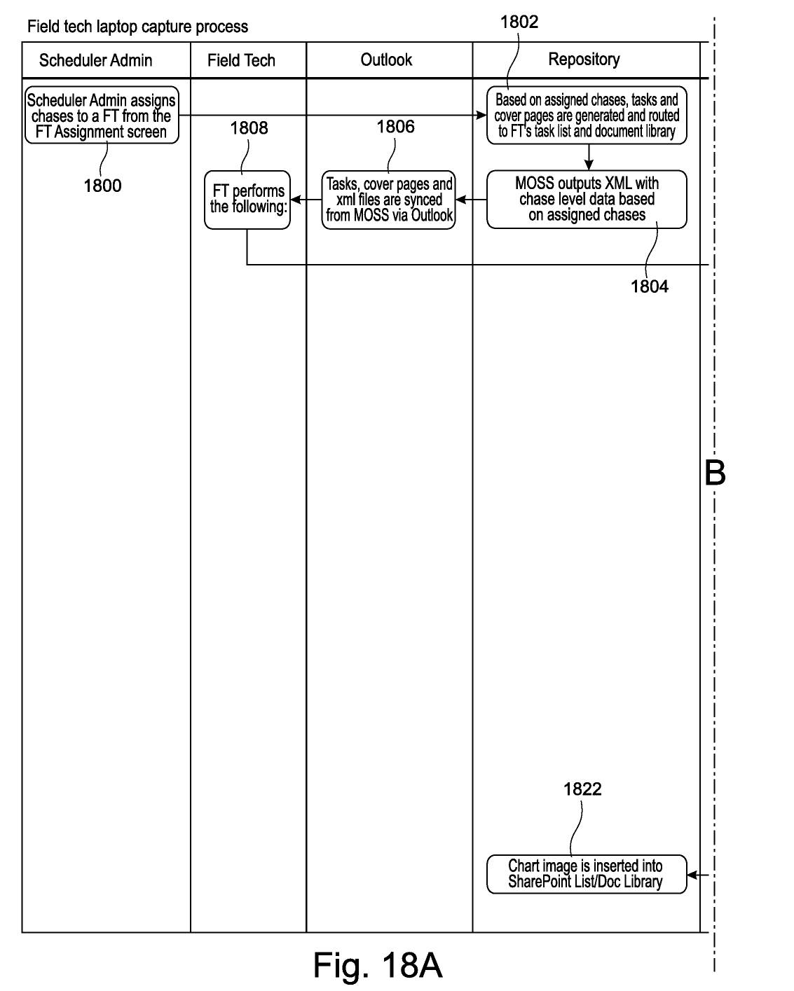

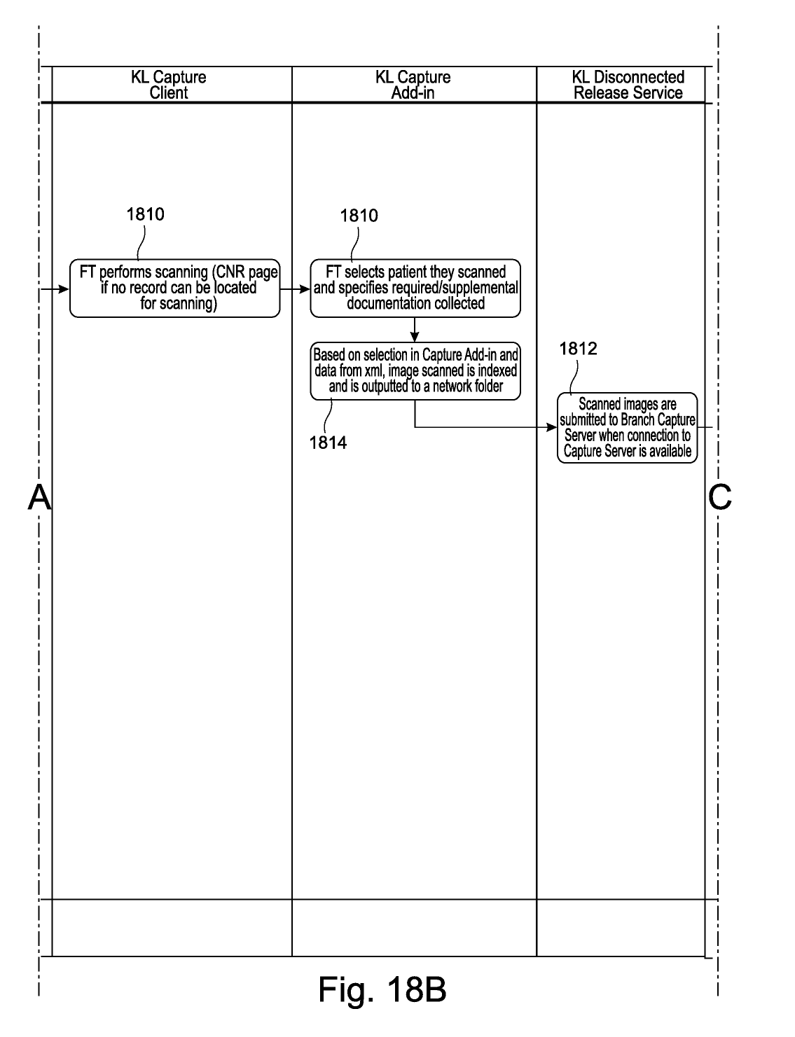

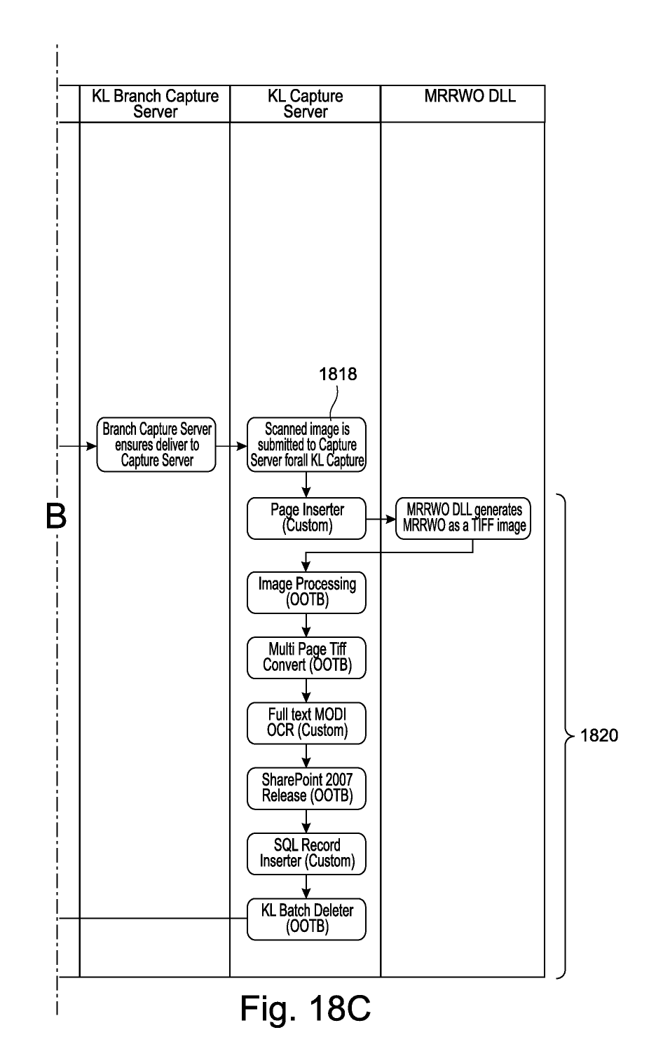

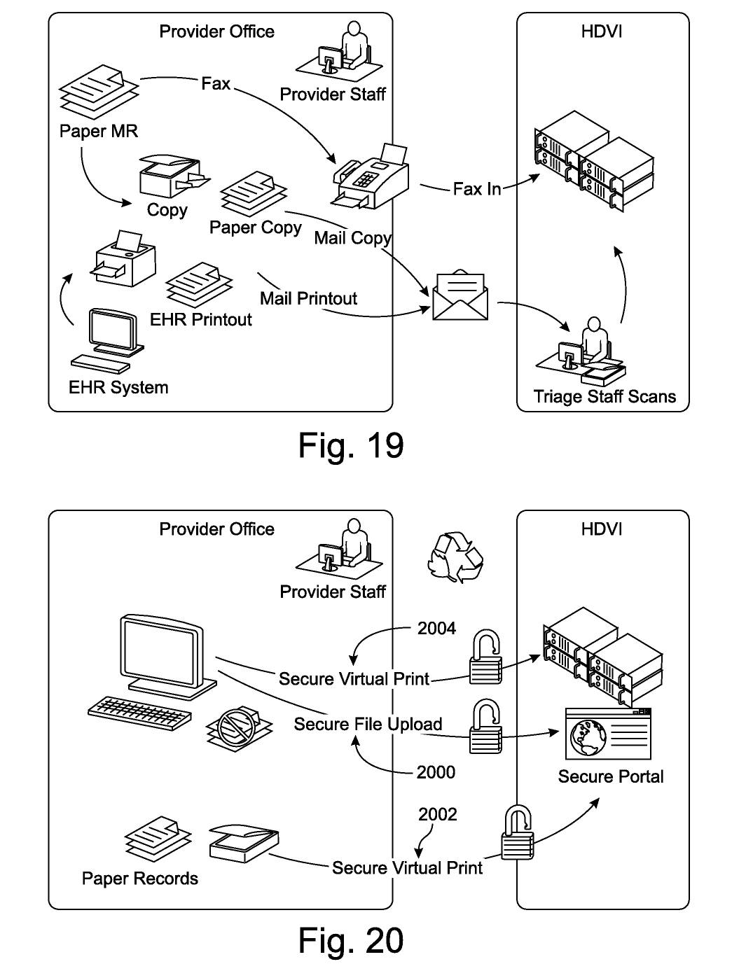

FIG. 18A-18C show an example of a process for a field technician to retrieve documents. The scheduler assigns 1800 the chase to a field technician. Based on the assigned chase, tasks and cover pages are generated 1802 and routed to the field technician's task list and document library with XML files 1804. This information may be received by the field technician via a communications software such as Outlook and synchronized 1806. The field technician can then perform the requested tasks 1808. For example, the field technician may scan 1810 the requested records. If additional or supplemental information is required the field technician can specify 1812 that as well. Any information scanned is indexed and outputted 1814 to a network folder. The scanned images may be submitted to an auxiliary server 1816 specifically designed for remote users, such as a branch Capture Server, and eventually submitted to the main server 1818. The images are processed 1820 and delivered to the repository 1822.

Triage

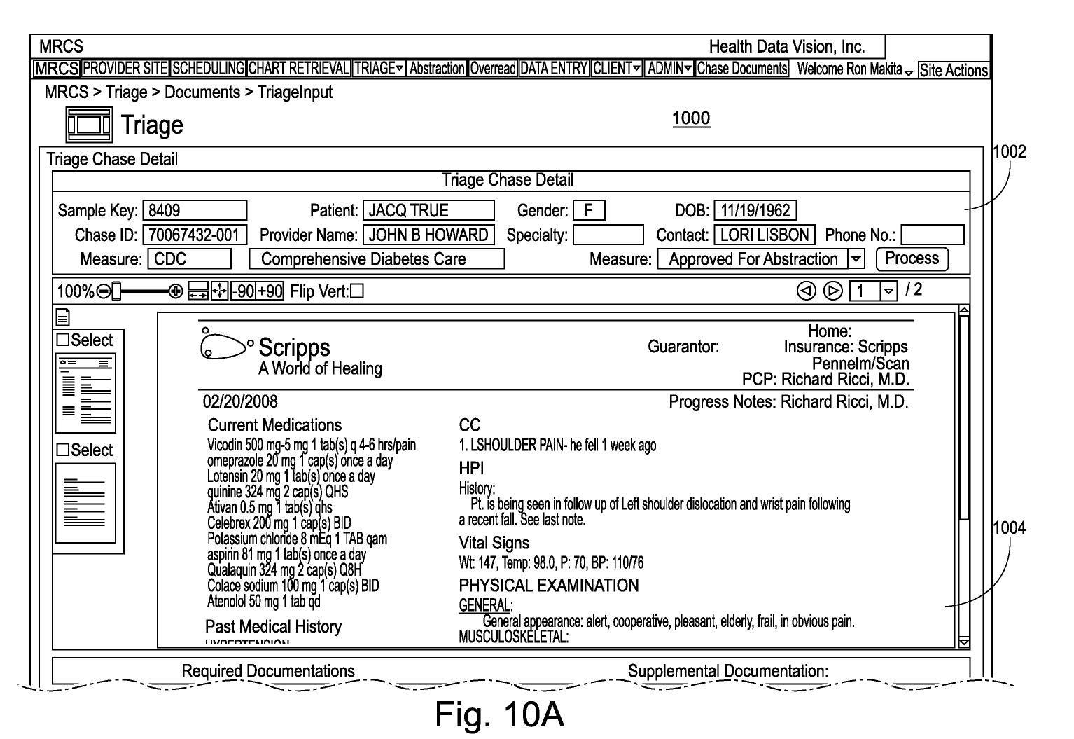

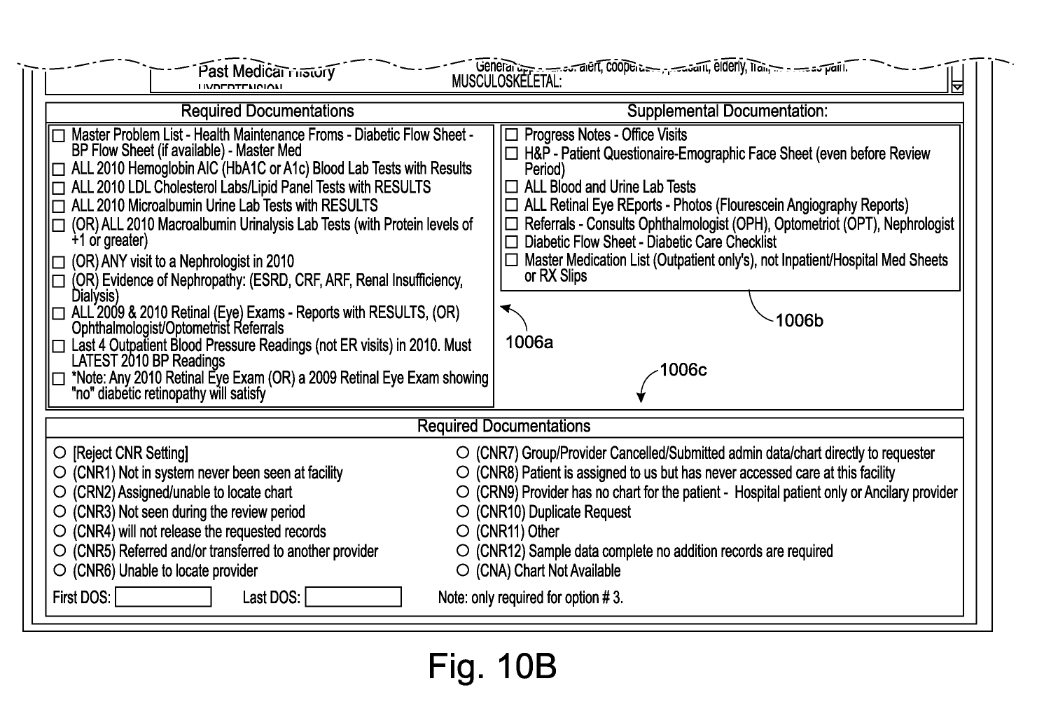

Records received by the system are quality checked, referred to as triage, by examining quality features, such as legibility, completeness, and accuracy by a triage staff member to assure the following steps have a complete chart record. Members of the team are trained to recognize document types and to check quality on each page of the documents. After the record is received into the system a team member views the worklist 254. The team member initiates the triage process 256, the status is updated to indicate that record is in the process of undergoing triage (TRIAG/INPR) 258, and the triage is performed 260. The team member opens each file, and quickly views the file to see if there are multiple members or patients in the file. If so, the file will be split so each file is assigned to the appropriate chase. The electronic checklist is filled out by a triage staff member for records that were faxed or mailed in as shown in FIGS. 10A-10B. Records submitted by the field technician are verified for accuracy by the triage staff. An electronic checklist may also be used for records submitted by field technicians. The triage staff may determine whether a chase is acceptable 262. If not, a provider may need to be re-contacted if a record is not complete or is illegible. In those cases, a notification is sent to the appropriate scheduler for secondary pursuit to retrieve the appropriate documents and the status changed to SCAN/RDY 226. In addition, incorrect or illegible pages may either be deleted or moved to the correct chase as appropriate. Thus, the triage step improves the accuracy and completeness of the record before any analysis is performed.

A sample triage chase detail 1000 is shown in FIGS. 10A and 10B displaying identifying information 1002, medical information 1004, and a checklist of documentations 1006a, 1006b, 1006c that may be required or useful.

Abstraction

Records that pass through triage are updated to indicate that they are ready for abstraction ABST/RDY 264 and made available to qualified abstractors who have access to review the records. Abstraction is the analysis conducted by the abstractor of the received records to look for the specific information requested by the client, including specific services for the patient (such as lab tests, prescriptions, screening tests, etc.) or all services provided. Abstractors have a wide range of qualifications and backgrounds, and include registered nurses (RN), licensed vocational nurses (LVN), licensed practical nurses (LPN), certified coders, registered health information administrators (RHIA), registered health information technicians (RHIT), and the like.

The system allows abstractors to be completely location and work-hour independent, thereby avoiding visits during provider office hours, navigating through traffic, parking, or other field logistics. Abstractors can work in a virtual office; specifically, they can work from home at any time, accessing the system through, for example, a secure browser over the Internet. Abstractors can be nationwide, and the system allows them to be assigned to projects based on their skills and expertise rather than their physical location.

Abstractors are grouped into teams that specialize only in certain measures depending on their specific backgrounds and testing results. They are assigned batches of records by measure rather than by provider. This has proven to be extremely efficient, as the abstractor can focus on a single measure, and does not have to know all of the measures.

The abstractor utilizes an abstraction viewer application to view the files and conduct the analysis. The abstractor receives the worklist 266 or 274 and initiates abstraction for the chase 268 or 276. The status is updated to indicate that the chase is ready for abstraction (ABST/RDY) 270 or 278 and the abstraction is performed 272 or 280. The abstraction viewer displays the chart and abstraction tool side by side, and entries automatically calculate and display measure compliance at both the sub-measure and full measure level. Each chase for a member is also abstracted separately and the results aggregated so there is no confusion on the services provided by each provider. If a member has multiple chases, the abstractor may view the charts and the separate abstraction results for the member. When entering review results, the page number of chart is automatically recorded. This is particularly helpful to administrators and clients that may review the results for quality. Additional meta-data, including a digital version (with optical character recognition) of the medical record may be used.

In addition to searching for services within a chart, if an abstractor finds a “clue” within the chart that indicates that the record is not complete for a required service, the abstractor has the option of putting the chase into a secondary pursuit. For example, a record may contain a notation indicating that other tests have been conducted at a different facility. A secondary pursuit is a process that sends a notification back to the scheduling team to either go back to the original provider, or to a different provider to further investigate whether other records exist. Secondary pursuit maximizes results by creating a complete file for analysis rather than ignoring or not recognizing that a file may not be complete or accurate.

In some instances, a record may be incomplete or inaccurate due to the non-compliance of the member or patient. Abstractors are required to select a reason code indicating the reason for non-compliance. Examples of reason codes include “Physician ordered test, but patient non-compliant”, “Test given but outside of timeframe”, “Test level out of range.” Reason codes are important, especially in post-project review and analysis.

Overread

Overread is conducted throughout the project to assure quality rather than at select points in time, such as a few records at the beginning of the process, which could lead to errors downstream of the process. The overread process checks the quality of the analysis or abstraction conducted by the abstractors to assure accuracy and completeness, i.e. quality assurance.

Abstractor's records may be overread 282 for quality by a senior abstraction staff member. If overread is desired, the status is updated to indicate that the chase is ready for overread (OVER/RDY) 284; otherwise, the status is updated to indicate that the chase is ready for data entry (ENTRY/RDY) 296. If overread is desired, the overreader views the worklist 286, initiates the overread process 288, and updates the status to indicate that the chase is in the process of being overread (OVER/INPR) 292. The overread scores may be displayed and calculated in real time, which identifies quality issues immediately and reduces any delay in taking corrective action.

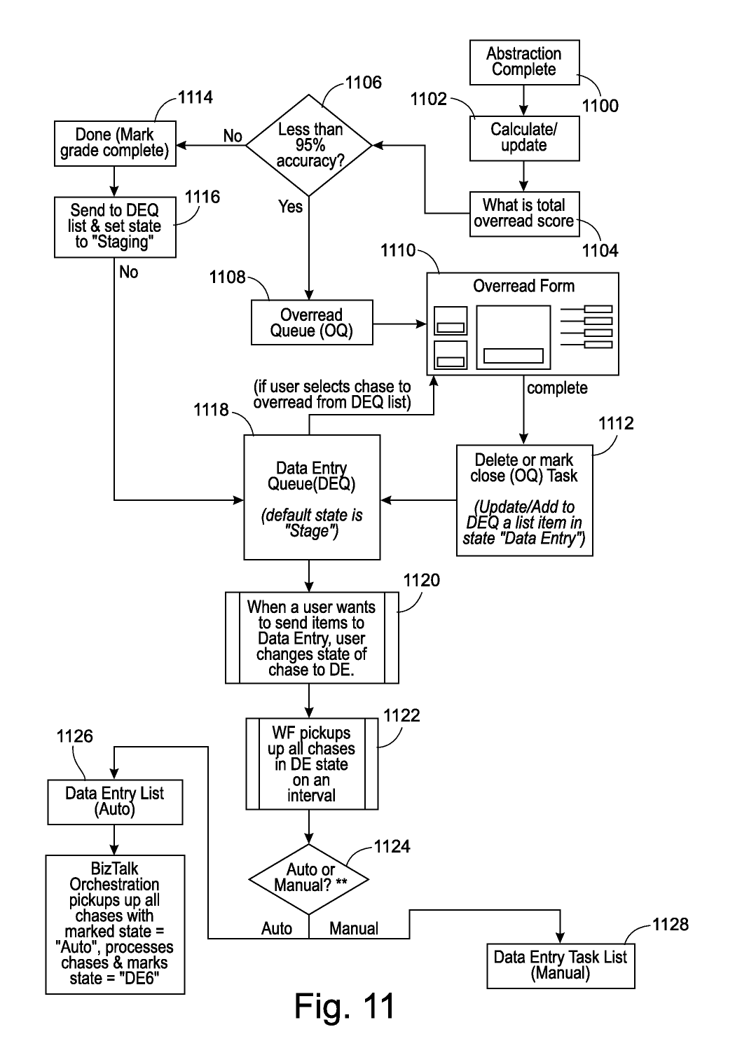

An example of the overread process is shown in FIG. 11. Abstractors start off at 100% or a score of 100. Once the abstraction is complete 1100 a report card is updated 1102 to the chase with a total overread score 1104. A determination is made whether the abstractor met his or her standard 1106. Any abstractor that falls below an established accuracy standard is flagged and corrective action is taken. The percentage of overread is set in the project configuration and varies by project and client. For example, abstractors are expected to meet a 95% accuracy standard. Any abstractor that falls below the accuracy standard may be re-trained to assure there is a correct understanding of the measure and the overread percentage is increased until the standard is achieved. An abstractor will be removed from the team if not abstracting at the predetermined standard.

Chases from abstractor who do not meet the established standard are added to an overread queue 1108 and overread again 1110. Once complete 1112, the chase enters the data entry queue 1118. If the chase meets the established standard it is marked as done 1114 and marked to send 1116 to the data entry queue (DEQ) 1118. The status of the chase is updated indicate that it is to be sent to data entry (DE) 1120. All chases designated as DE are picked up 1122 and a determination 1124 is made whether the data entry is conducted automatically 1126 or manually 1128.

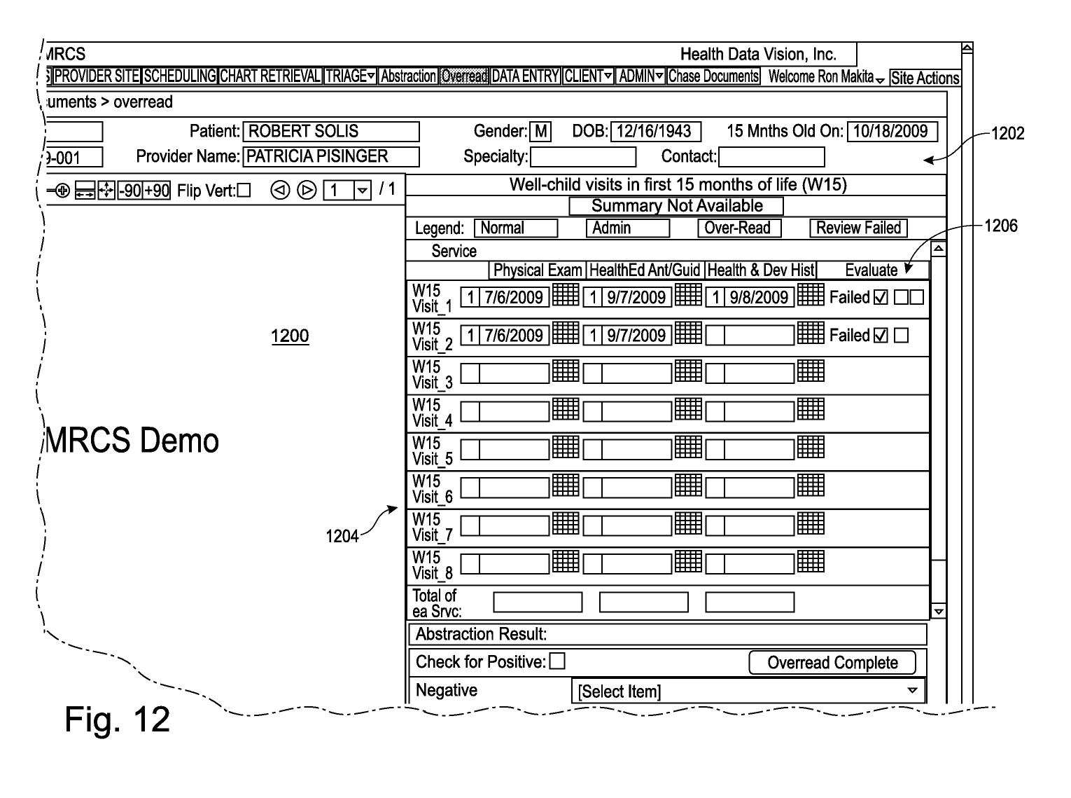

A partial sample overread form 1200 is shown in FIG. 12 displaying the patient's information 1202, the service information 1204, and the results of the overread 1206 for each service provided.

Client Review/Client Portal

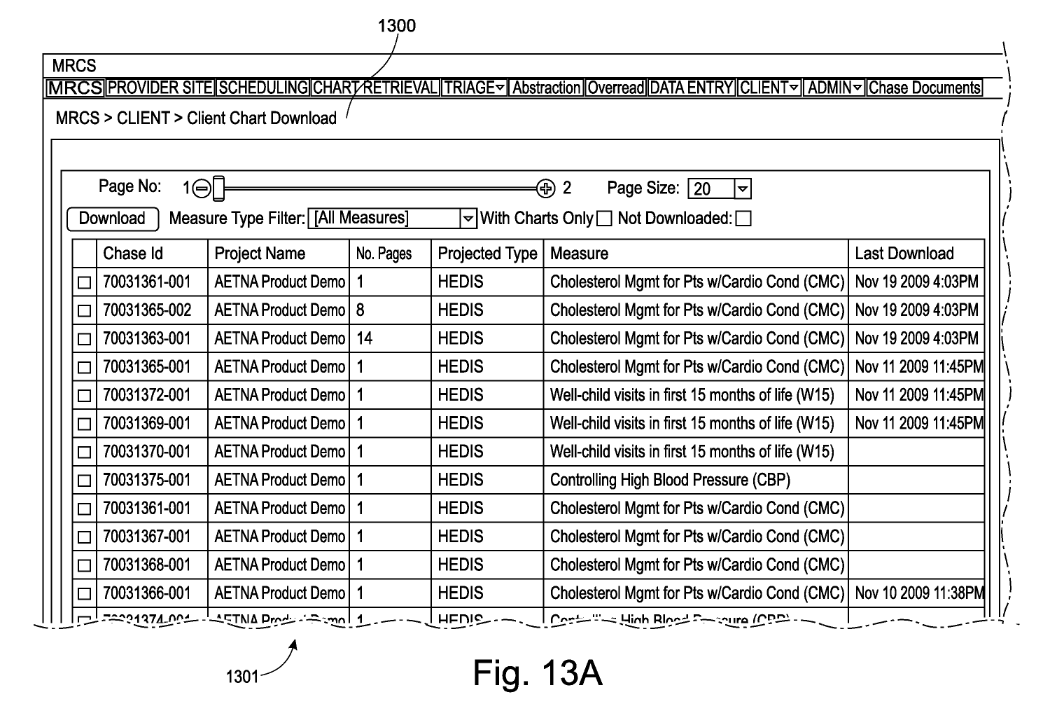

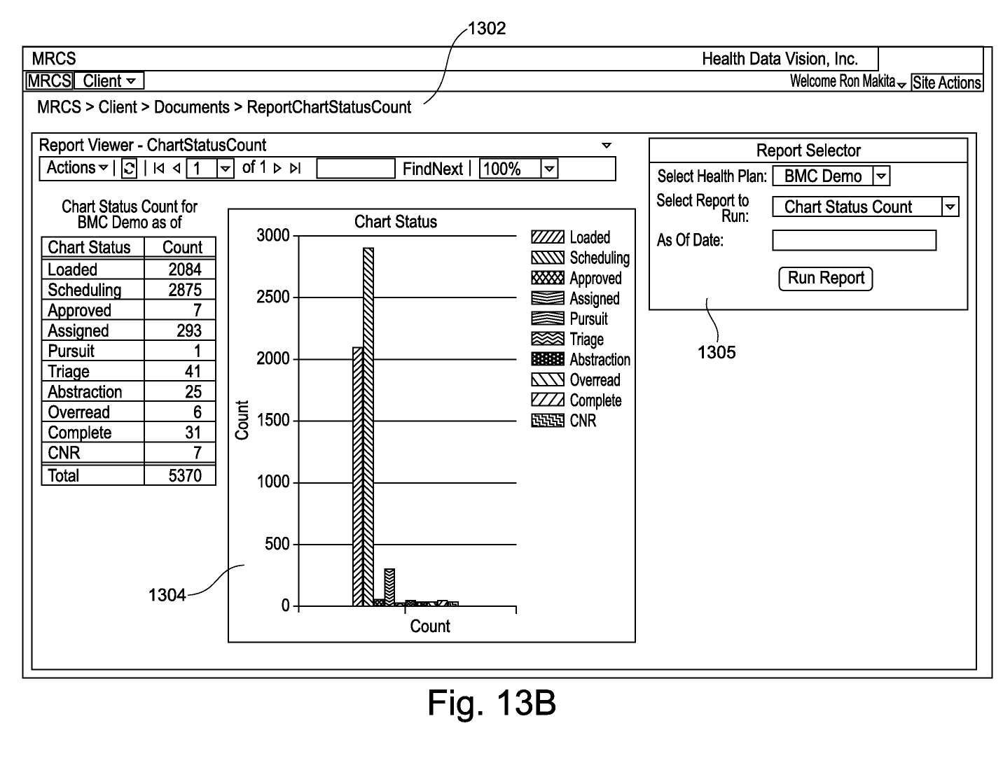

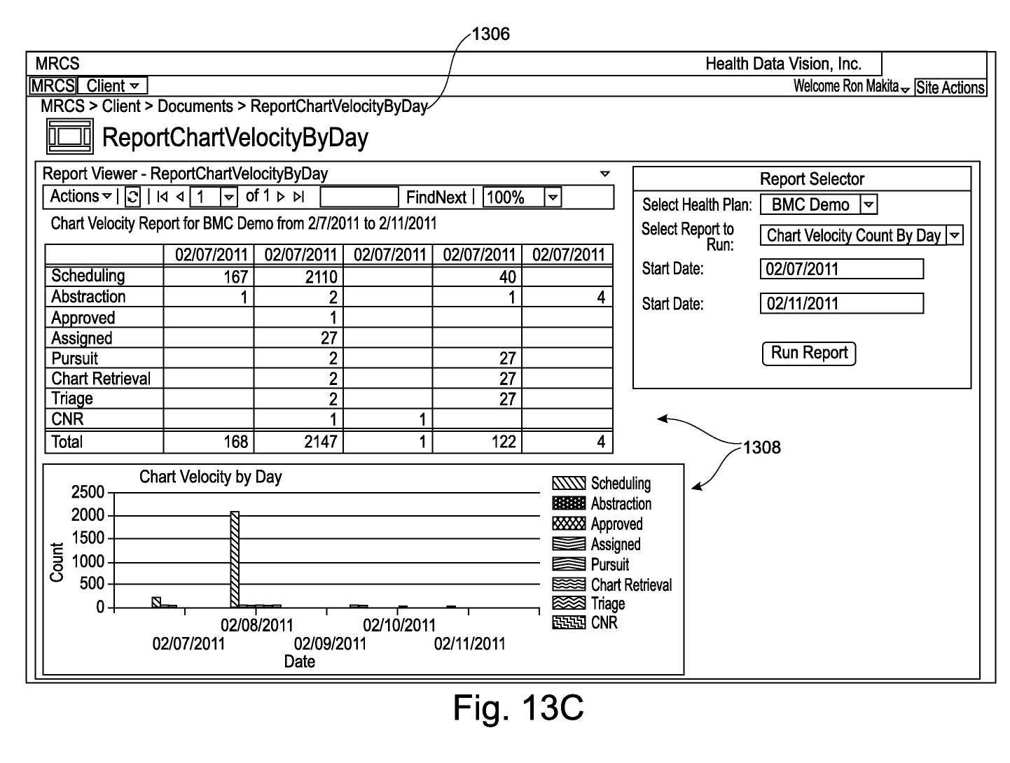

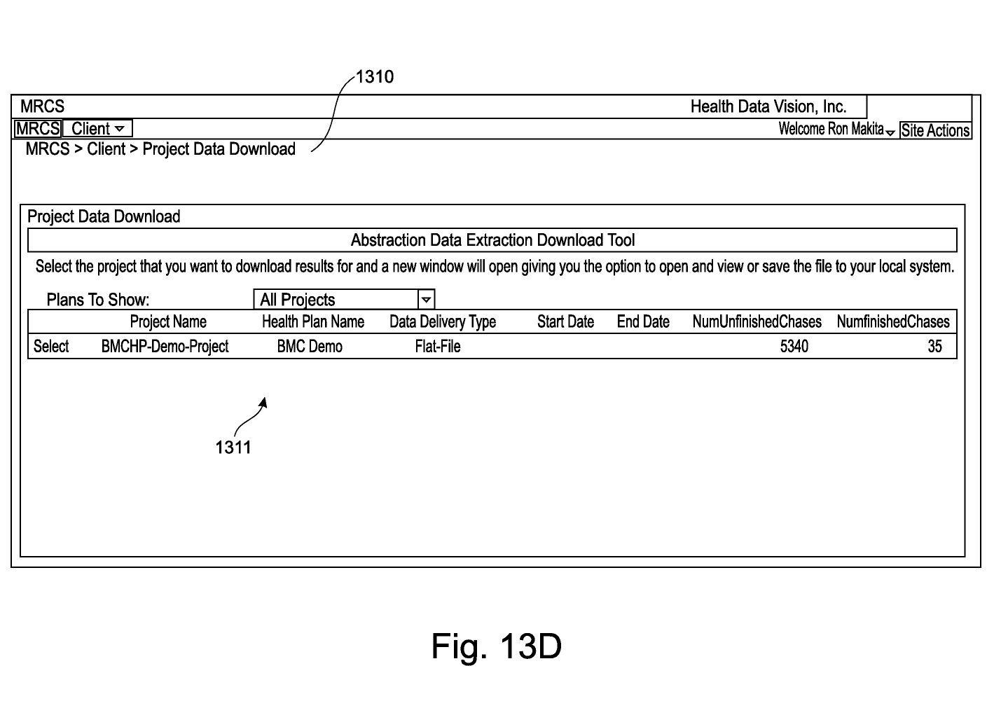

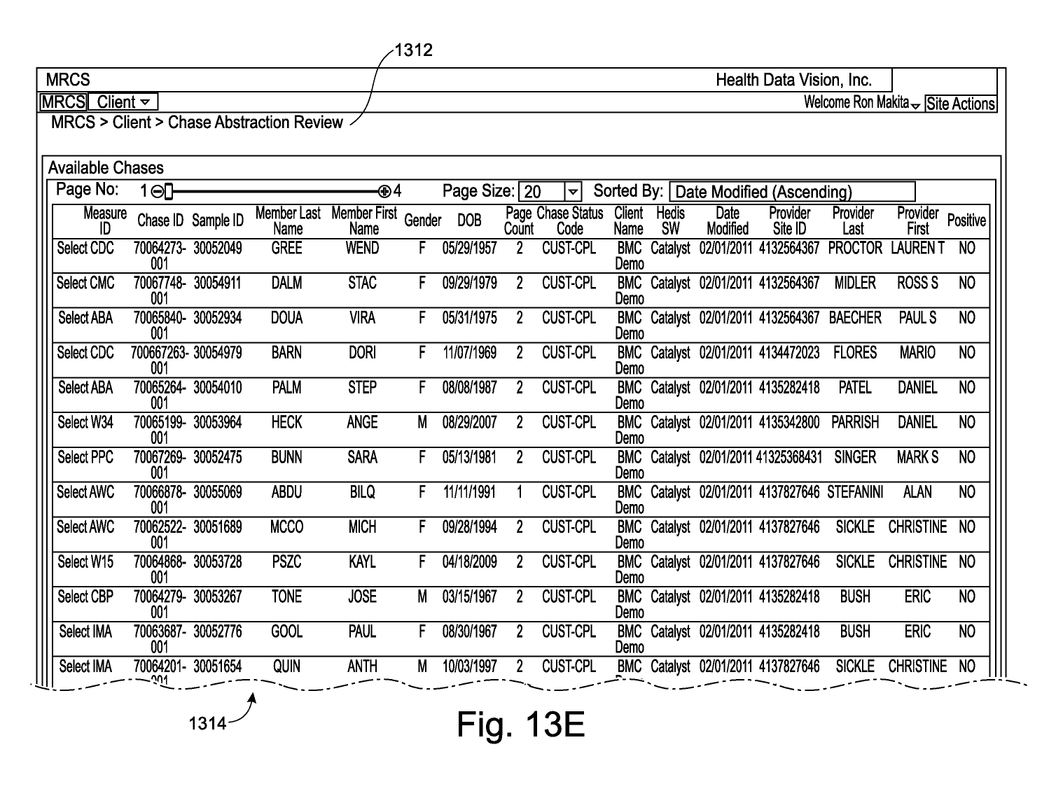

Clients can use the client portal section of the system to monitor and review their requests. A portal, whether it is a client/requester portal or a provider portal, is essentially a website that the client or provider can access securely to interact with and access designated, specified, or authorized medical records or documents on the system. For example, as shown in FIG. 13A, client chart download feature 1300 allows clients to locate and download charts 1301 in a .zip file for further use or analysis. This is typically necessary to pull sample charts and analysis for auditors. This ‘on demand’ feature makes this process extremely easy and efficient. In a specific example, all charts that have passed through overread may be available for client to review or download. If desired, client may view the abstraction results for accuracy of abstraction and provide feedback to the lead abstractor.

As shown in FIG. 13B, a chart status report feature 1302 shows in real-time the status 1304 of the different chases in a sequential fashion, allowing clients to keep up to date on the project progress. Drill-down capabilities 1305 allow viewing of different sub-groupings of the information (e.g. by analysis type) all the way down to the individual instance level. This is made possible because of the way the system breaks down and tracks all the events in the process. In addition, the type of reporting and the near-real time refresh of report data enable the real-time nature of the report.

As shown in FIG. 13C, a velocity report feature 1306 shows the actual activity 1308 on a daily basis, i.e. what tasks have been performed in each stage of the process. Again, drill-down capabilities allow more granular analysis. This report also updates in real-time for the current day in the report. This detailed analysis allows clients and the system to precisely manage the pace of the project, identify any bottlenecks and other irregularities, hence providing a new tool to effectively and predictably manage these types of projects.

As shown in FIG. 13D, a project data download feature 1310 allows the client to download any analysis information 1311 in the client portal in the specified format (see project configuration), for further analysis or for import into another system whenever the client pleases.

As shown in FIG. 13E, a client abstraction review feature 1312 allows clients to perform their own check on the abstraction work done 1314 in the process. This feature is used to perform a client's own quality checking on the work done in the system and provide feedback to the project team.

Clients may have 24 hour access to real time project status reports. Every provider, chase, and chart status is tracked in detail and reporting may be available on the overall status, specific measure status, trend to completion, and drill-down capability to a provider or the actual chart itself.

Delivery of Results

The system may consolidate the abstracted data and deliver a flat file at scheduled intervals in real time or on demand. The system may contain mapping configurations and data transport methods with each client to assure proper format and file transfer.

Computer System

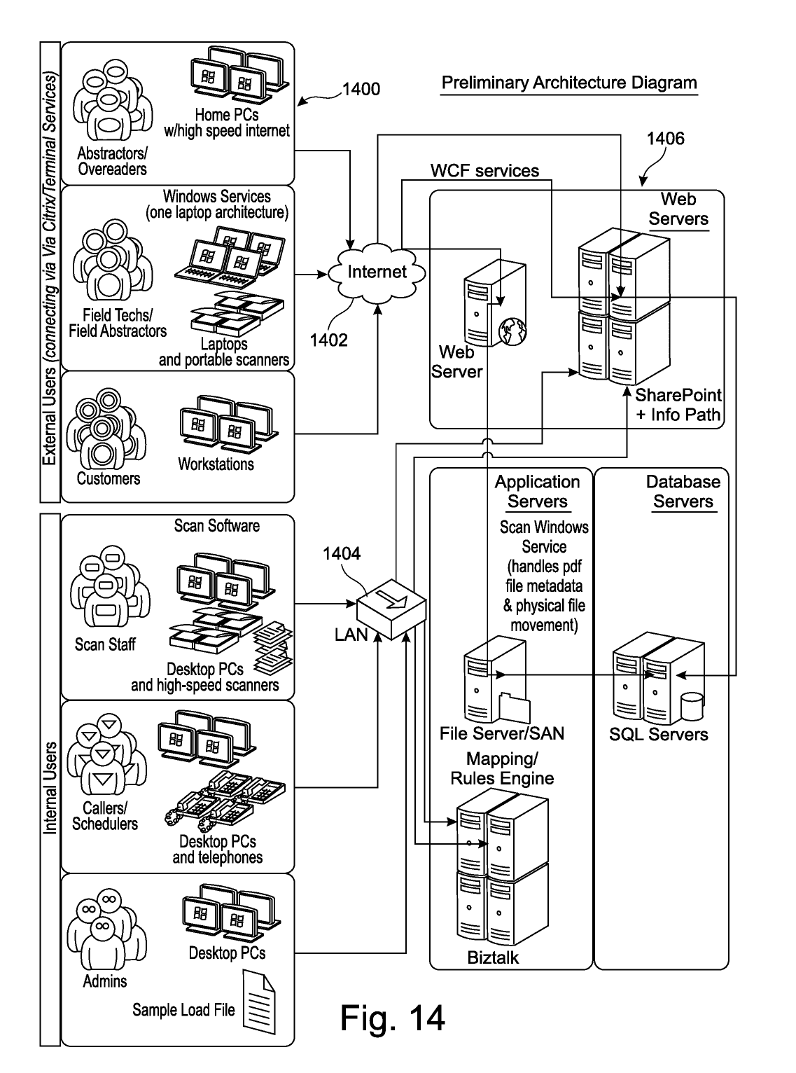

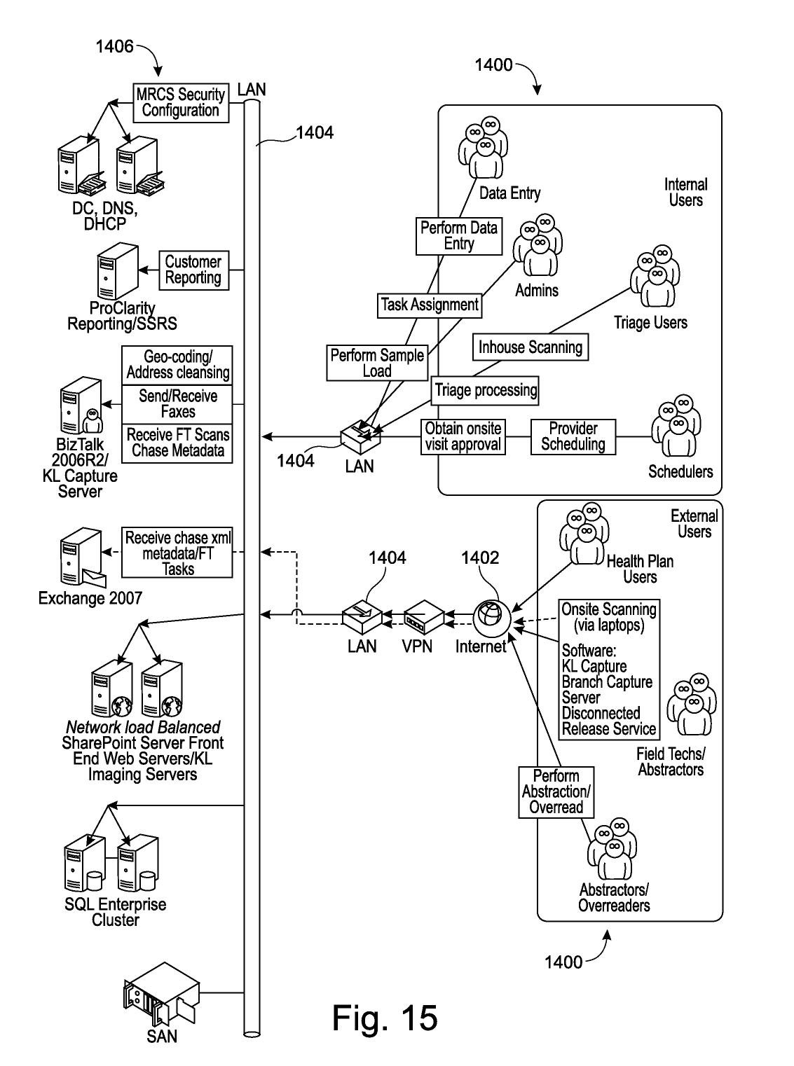

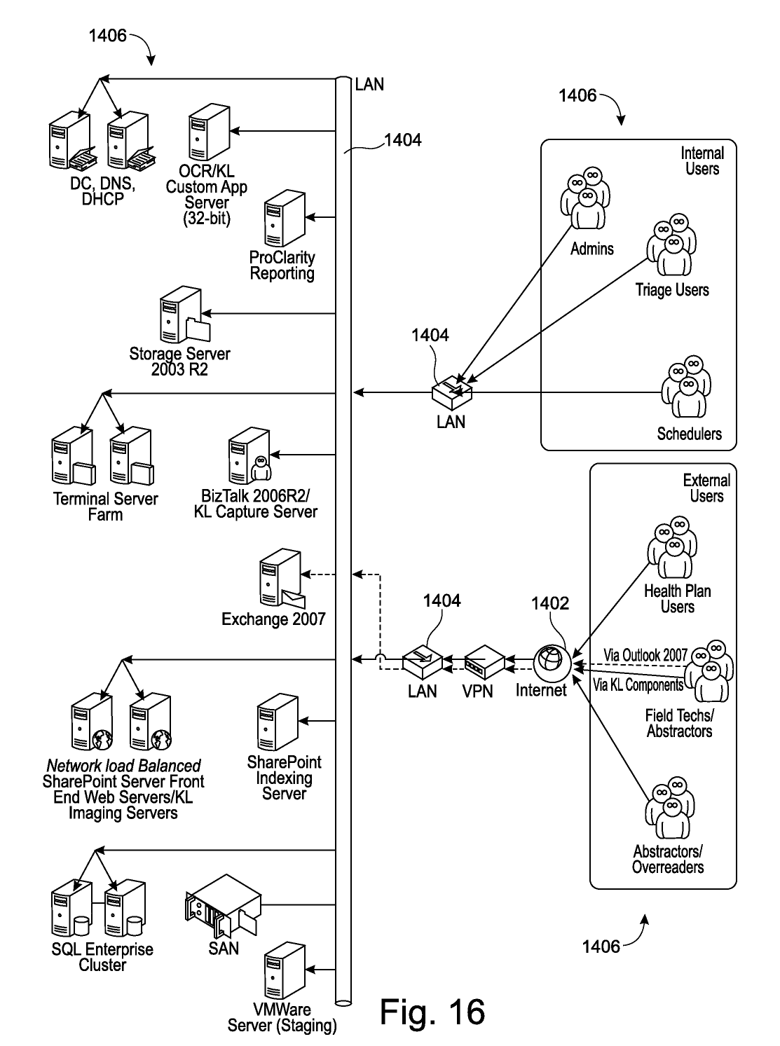

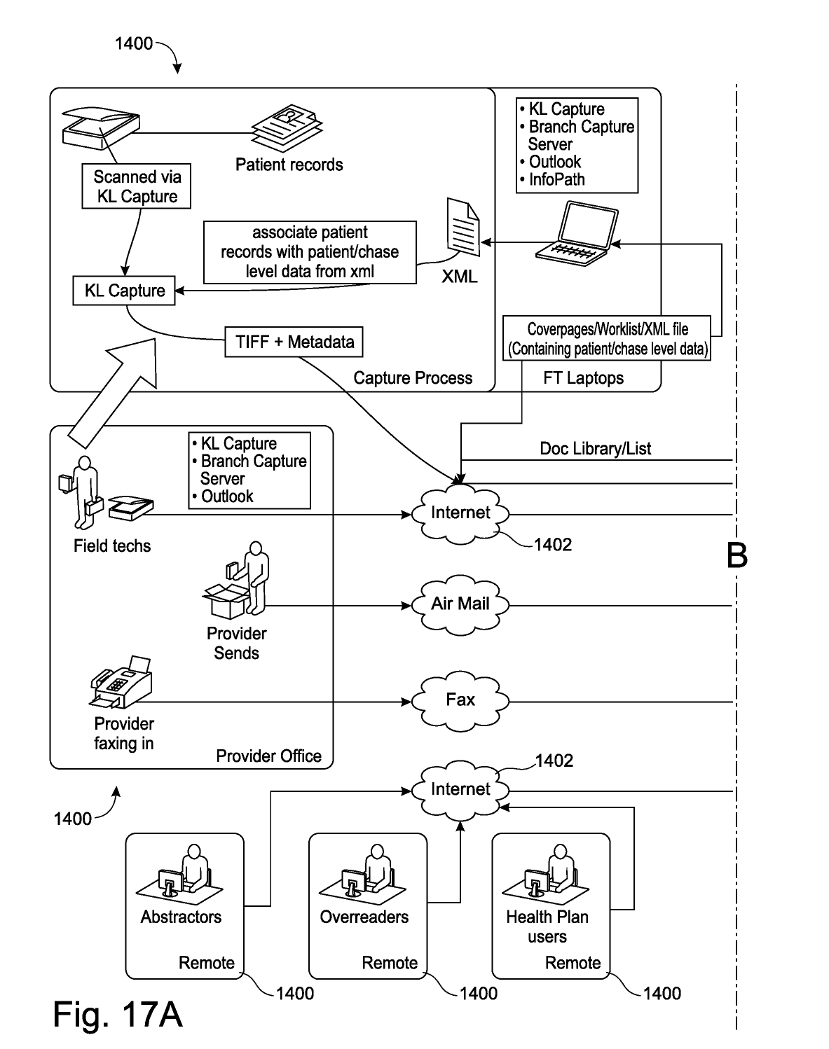

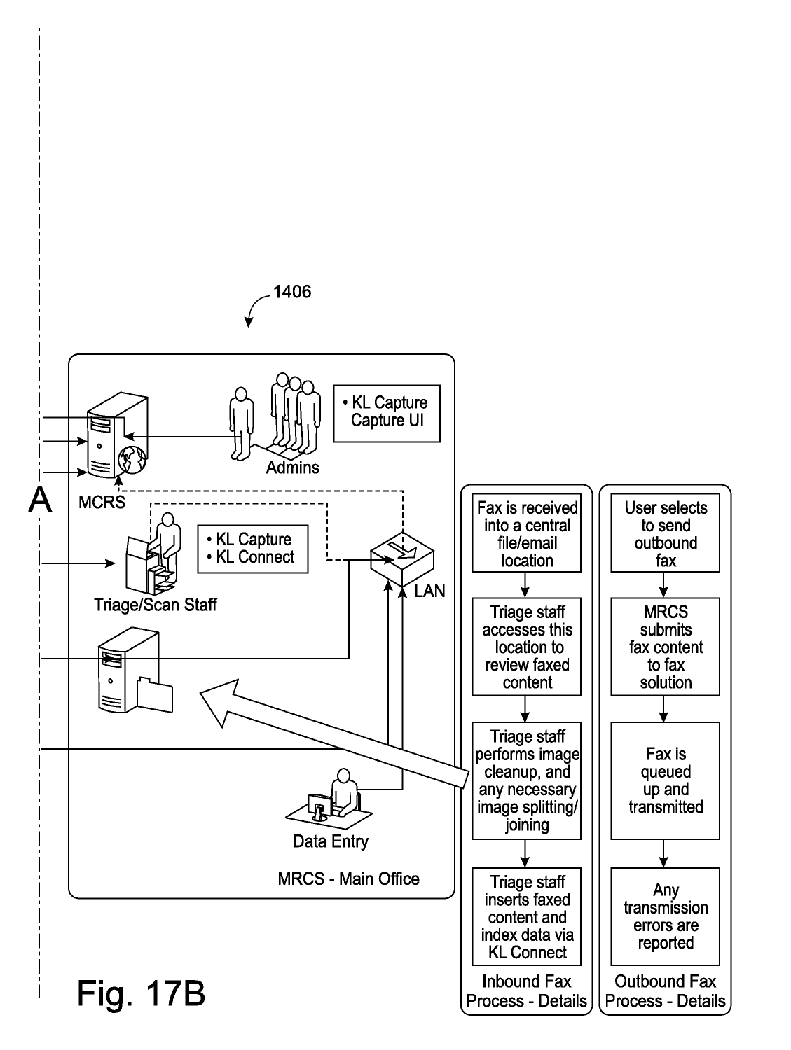

FIGS. 14-18C show examples of the architecture to implement the system. These are provided as examples only and are not intended to be limited to these specific examples. In some embodiments, the web-based front-end of the system runs on Microsoft SharePoint Server, using its Microsoft SQL-Server based document repository on the backend as well as other features and custom code. The loading of data, exchanging of inbound and outbound fax messages runs through Microsoft BizTalk Server, which integrates with external services for address cleansing, geo-coding, fax delivery and receiving as well as Microsoft BingMaps for mapping in the scheduling and field-tech assignment functions of the solution.

Security of the system is handled through a modern, firewall setup. The firewall solutions used Microsoft ISA Server and secure traffic is ensured via HTTPS, with a security certificate issued by a trusted security authority.

The portal is structured into different ‘sites’, each of which serves a specific function in the process.

The field technician laptops use a secure HTTPS connection to link up with the central system to download itineraries and to upload scanned charts to the central system. The laptops are secured and locked down (files cannot be copied, printed, or emailed externally, only uploaded to the repository), full-volume encryption ensures that data cannot be compromised). Microsoft Outlook may be used to synchronize itinerary items as tasks. Data from the tasks is passed to MS MapPoint and to KnowledgeLake (KL) Capture client, the scanning client software. This ensures that there is no mis-typing of patient names or other information. A valid selection needs to be made for a medical chart to be associated, eliminating orphan records and mis-associations, both major problems in the industry.

Small, portable and fast scanners are used to scan records on site at provider offices.

The system can take the form of a computer program product, such as a computer-usable or computer-readable medium providing program code for use by or in connection with a computer. For the purposes of this description, a computer-usable or computer readable medium can be any apparatus that can contain, store, communicate, propagate, or transport the program for use by or in connection with the instruction execution system, apparatus, or device.

The medium can be an apparatus or device that utilizes or implements an electronic, magnetic, optical, electromagnetic, infrared, semiconductor system, or propagation medium. Examples of a computer-readable medium include, but are not limited to, a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices 1400 (including input-only and output only device, such as, but not limited to keyboards, displays, pointing devices, disk drives etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present system can utilize the World Wide Web (“WWW”) or (“Web”) site accessible via the Internet 1402. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) 1404 and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize analog telephone lines, digital T-1 lines, T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided by online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer 1406 connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs for execution on a remote computer. Likewise, a web server may also include facilities for executing scripts and other application programs on the web server itself.

A remote access user may retrieve hypertext documents from the World Wide Web via a web browser program. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

With the computer architecture in place, in some embodiments, a universal medical records processing system can be utilized to efficiently, effectively, and securely transmit requested medical records from the records provider directly to the system or some other system requesting the records. This could reduce or eliminate the need for field technicians. Without the need for field technicians, there would not be a need for scheduling and assignment of field technicians. If the client has its own quality control staff, then a third-party triage team, abstraction team, and overread team can also be eliminated, allowing the client to perform these functions.

Up to this point it has not been practically possible to capture electronic medical records (EHRs) from any system for secure transmission via an electronic interface transmitting actual data elements due to the lack of standards, commitment, and capabilities to adhere to standards by hundreds of vendors, government agencies, providers and payers, while at the same time needing to comply with security and privacy regulations. It was simply unrealistic to expect a broader adoption of a meaningful data-level integration in the foreseeable future.

Now, an approach has been conceived to capture digital records and securely process them in the form of images in a way that cannot be achieved by current systems. This approach overcomes compatibility issues with hundreds of electronic medical or health records (EMR or EHR) systems with proprietary and often changing interface standards, platform and data transfer limitations. It furthermore elegantly bypasses any security limitations or violations by making the need for third-party access to EMR systems for record retrieval obsolete. It allows personnel at the provider to perform all the steps in an efficient manner, which is to their advantage as the medical records retrieval process becomes least intrusive to their general operations. It also provides cost advantages for the system and/or the clients or requesters since the cost of retrieving records (relative to traditional methods) is significantly lower. It eliminates the use of paper and labor-intensive steps (e.g. site visits by Field Technicians). In addition to the current use of Field Technicians, the approach also has significant advantages over the practices of provider offices faxing or mailing paper copies of medical records as it saves cost and is arguably more secure.

The major steps in this transmission process include both the request transmission and the response to the request, which is the transmission of the medical records or documents.

First, the request for medical records is transmitted to the provider. For example, a request for one or more records for a given initiative (quality project, risk adjustment audit, etc.) may be sent to the provider via email (with a secure link to the portal where the protected information is stored), fax, mail, and the like.

Then, the provider looks at the requests and prepares a response. In preparing the response, medical records or documents should be in electronic format. In some situations, the records may already be in an electronic format. In other situations, a hard copy of a medical record or document may be be scanned into an electronic copy. Once an electronic copy is ready, to the provider can upload the electronic copies to the portal. In some embodiments, the electronic copies or files will be generated out of its EMR system and saved locally for upload. Alternatively, the provider may choose to “virtually print” the electronic copies to the system for retrieval by the client. For secure virtual print, there is no intermediate step.

By way of example only, for file upload, the provider logs into a provider portal and follows a wizard for each member, specifying the metadata for the file to be uploaded. Then the file is uploaded for each member. For secure virtual print, the provider selects the relevant medical records for a member, then selects ‘Print’ and follows the wizard to define the metadata, generate the image and securely transmit it to the system. For ‘Scan to Portal’ the provider logs into the Provider portal, follows the wizard to select the appropriate metadata for the records to be scanned, then scans the records, which will be automatically processed into the system.

As shown in FIG. 20, the universal medical processing system allows for the capture of electronic health records information or hard copy paper records as a medical record image (case.g. multi-page TIFF) to be transmitted securely to the system. Electronic health records that have been uploaded directly into a portal or virtually printed by providers can be tracked and the project status monitored.

In some embodiments, the provider securely uploads 2000 or 2002 an electronic image to a portal 304. This approach is very different from any existing cloud sharing or file storage systems. Current services are general file storage and sharing services which require simple user permissions. The portal upload of the present invention not only requires permissions, it only allows upload for authorized and authenticated users in response to a very specific, authenticated request for the document(s).

In some embodiments, the provider virtually prints 2004 the electronic health record via a secure connection into the system repository for further processing. This approach is very different from printing to a local printer, network printer or even a print service over the world wide web. It not only requires a more secure printer driver installation and configuration process, which authenticates the medical services provider by name, national provider ID, and location (through phone and IP Address verification). Virtual printing is only allowed for documents in response to a very specific, authenticated request for the documents. In some embodiments, the processing system enables the direct exporting of electronic medical records independent of the system, vendor, platform and data format for universal compatibility and adoption. For example, other destinations include Consumer Health records repositories such as Microsoft HealthVault and Google Health, and even repositories between physicians and specialists.

By implementing this processing system, visits by Field Technicians can be avoided completely, saving time, money, resources, and the potential for error or loss due to printing and handling of mailed paper medical records as is required in prior art systems. In addition, eliminating the printing of hard copies and handling of mailed paper medical records make the intake and routing of medical records more automated. Furthermore, this process system increases flexibility and scalability by making the medical records processing component of the collection system more versatile, providing additional intake channels, and providing more output and routing options, which may include third party systems as destinations in addition to the collection system.

Consistent with the previously implemented best practice of providing detailed, authenticated (confirmed legitimate request for records by the requesting party—e.g. health plan, patient themselves), the new approach implements an efficient way to receive requests for medical records (either via batch import of flat files, XML or via a secure web service for real-time requests) and processing/routing them to the appropriate provider (see scheduling above). In addition to the already existing faxing of lists, however, the system will also generate mail or emails to providers, depending on the provider preference. The default method is email The email will be sent to the designated provider's contact email address from the provider profile. It does not contain any sensitive information, but a link to the provider portal, which shows the list. Clicking the link in the email will take the provider to the portal login screen, and, upon successful login, directly to the desired list to work through the medical records requests as discussed above.

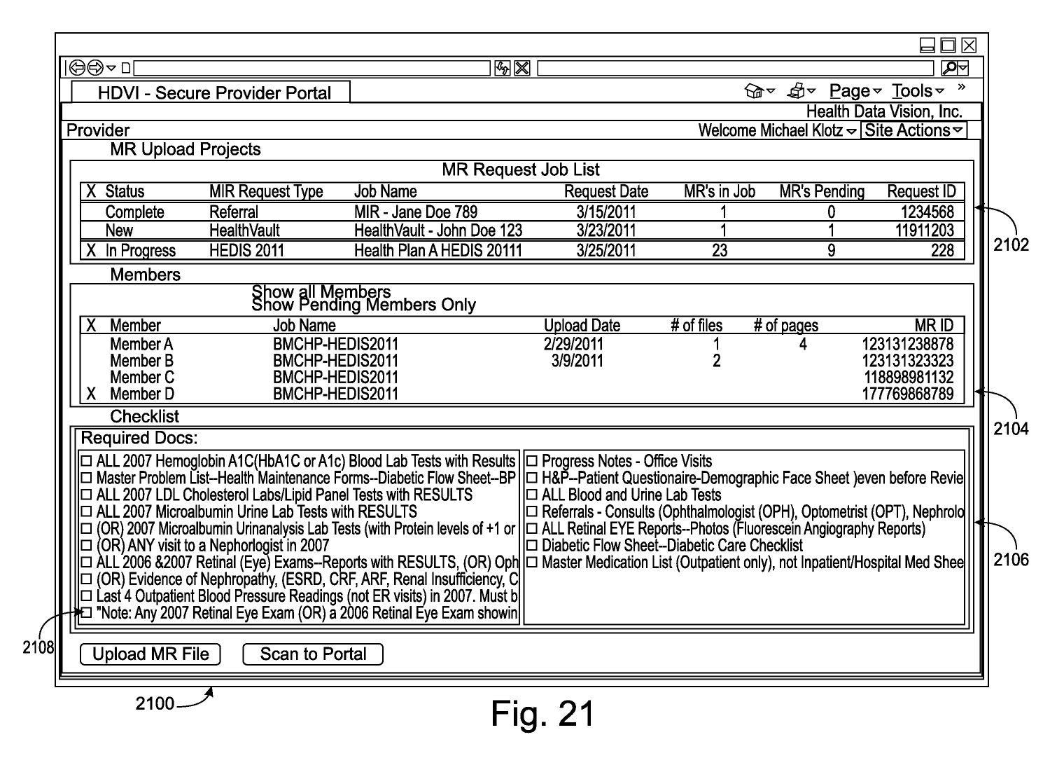

The medical records collection system may provide a tab or link to securely enter or login to the provider portal for configuring and monitoring requests. FIG. 21 shows a screenshot of a provider portal 2100 to which medical records may be uploaded. A list of requested jobs 2102 may be displayed for the provider to view the requests currently received to date. The list of members/patients 2104 may also be displayed for the provider to select the members for which medical records need to be uploaded. The list of members 2104 that are displayed can be configured so that the provider can view and sort the desired list of members. For example, the provider can view all members, pending members only, or any other type of member. Just like with other collection methods (Fax, Field Technician, Mail-in), the provider receives a detailed request/checklist for each submission. Therefore, once the member is selected, a list of documents 2106 is displayed with a selection indicator 2108 associated with each document. The provider can select the documents to be uploaded. The selection indicator for the selection of a document can be by any means, such as a checkbox, highlighting of the text, a change in font, underlining or bolding, or any other change in the appearance of the selected text that distinguishes it from non-selected text. Once the documents have been selected, the provider can securely submit the records to the collection system by uploading them through the portal. The uploaded document may then be processed in the system as any other medical records processed in through other channels, e.g. go in the triage queue for further processing.

In some embodiments, hard copy of medical records can be uploaded to the provider portal via a scanning device. The procedure for uploading the medical record may be the same as outlined above, with the additional step of scanning a hard copy of the medical record first. The scanning step may be accomplished by a flatbed scanner, a handheld scanner, a digital camera, a copier, and any other device that can capture an image of hard copy documents. The provider will be able to utilize browser-based functionality provided by the system, which will utilize proprietary screens as shown in FIG. 21 which also enables scanners to interact directly with the system.

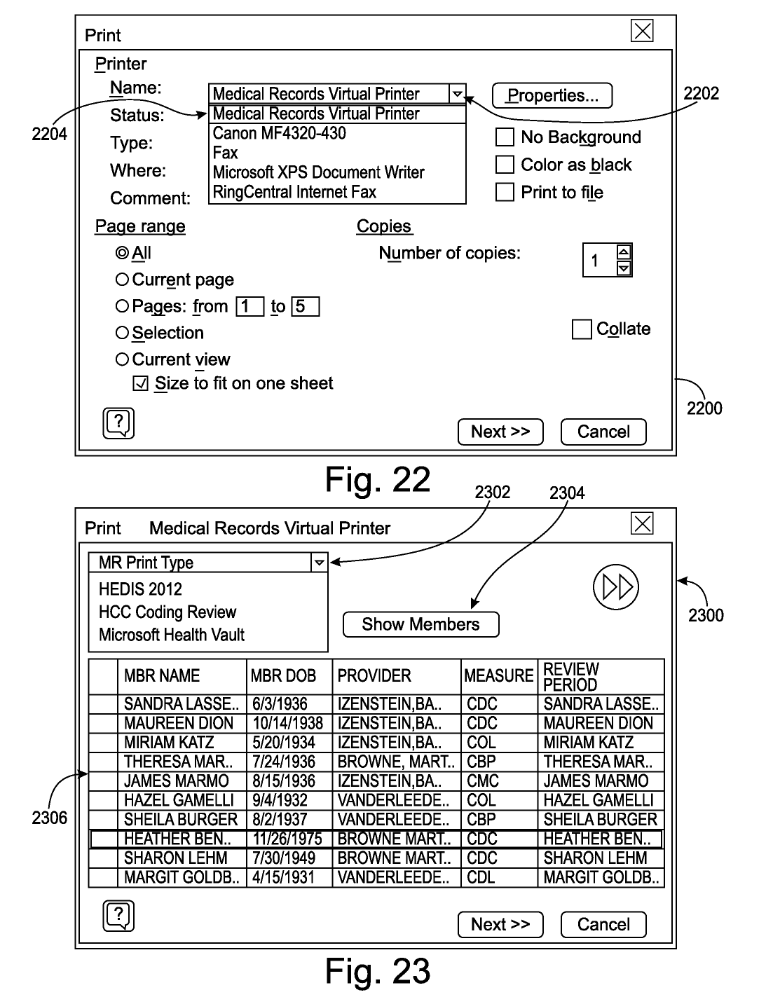

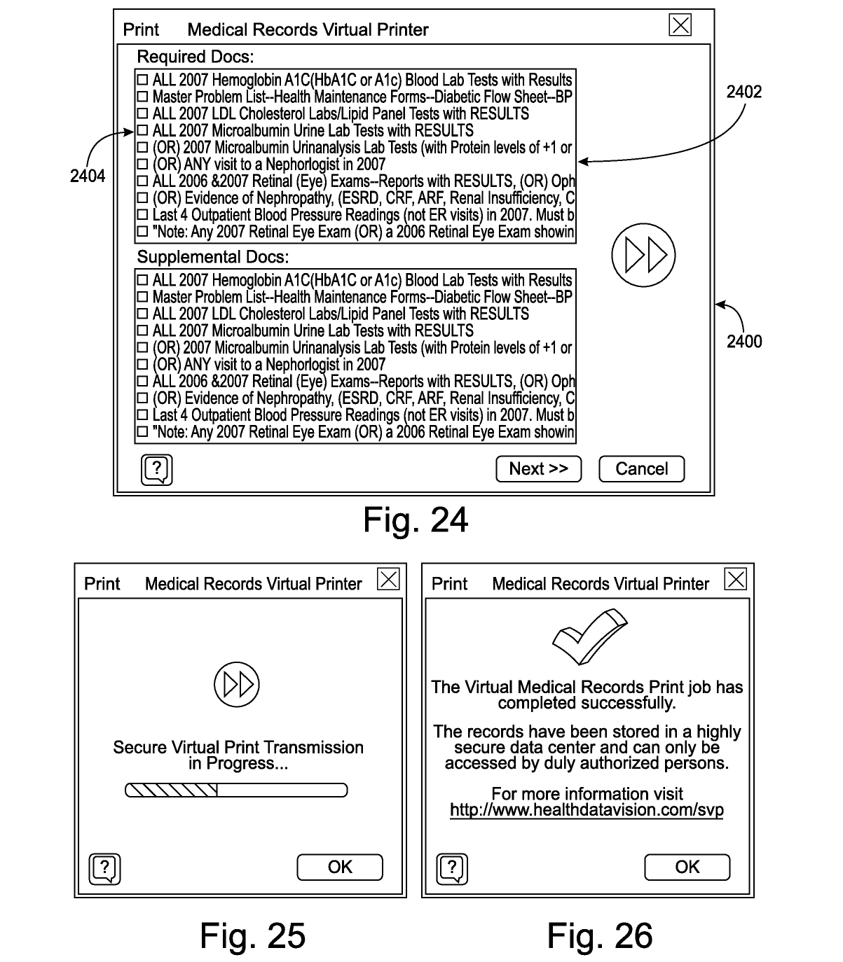

In the virtual print embodiment, a print driver may be installed on the provider's computer, which allows provider personnel to simply select a different printer option when printing electronic medical records. As shown in FIG. 22, selection of the print function displays a new window or dialog box 2200 with printing options. For example, a drop down window 2202 may display a list of printer options, including the option to virtually print to medical records collection system 2204. Therefore, instead of printing on paper or creating a PDF, XPS or other electronic document, the ‘printer option’ will allow them to send the records directly to the collection system and/or other systems. Unlike current remote printing systems, since the documents are virtually printed rather than actually printed as a hard copy, a printer is not required. Furthermore, a human recipient is not required to receive and open the document for processing like an email attachment. Rather, due to the metadata associated with the documents, the documents are sent directly to the repository and stored according to the metadata.

This method may have the most profound impact on how medical records are collected and processed in the years to come. As with the portal upload, the steps are similar. However, in this scenario, there is no need to log in. The print component will have been configured at the time of installation, which includes the identification of the provider and testing of the connection to the secure web service.

The printer component installation and configuration follows a set number of steps to ensure it is completely configured, and most importantly, that only authorized personnel at an authorized provider location are able to see requests and submit records in response to those requests.

First, the provider sets up an account through the system. After becoming aware of the secure virtual print option and deciding to use this mechanism for medical records request processing, a provider will create an account on the provider portal. Information such as physician and or provider group name, address, phone, fax, email, contact information and their national provider ID (NPID) need to be specified. The system verifies the information in real-time and ensures that the information matched the information for the NPID in the national provider database.

After this step has been completed, the provider will be directed to a page where it can start a download of the virtual print driver component. The download is a standard, browser-based file download. Instructions on how to save the file on the user's system and/or install the component are also provided on the download page. The component installation process uses a standard installation wizard which prompts the user for information and decisions as necessary (e.g. location of the installation, etc.). Once the installation has been completed, the user will be asked to provide the login information previously created in the account setup. The subsequent step in the setup process is the print component attempting an automatic login to the system backend system with the credentials provided. If it is not successful, it will instruct the user on troubleshooting or direct them to technical support. If successful, the user will be notified that the setup has been completed and that there are only verification steps remaining, which will be performed via phone. At that point, the component will also have captured and transmitted to the system backend certain computer-related information (e.g. IP address) about the provider's computer which will allow the system to authenticate the location of any future connections and transmissions for a given provider.

Once a provider has successfully created its account and/or set up its secure virtual print component, a request will be generated for the final verification steps. These steps are manually performed by a provider relations function. A representative from this department will verify the provided information against information from the national provider database and research any discrepancies. Once complete, an authorization code is generated, the provider contacted at the specified phone number (to ensure two-way authentication) and provided with the authorization code, which the provider will then enter into a configuration screen for the secure virtual print component. Once completed, the setup process is complete. Providers are then encouraged to go to the provider portal and configure any preferences, including how they want to receive the requests for medical records. The system offers email (with secure links to the portal), fax or mail By default email (with secure links to the portal) is configured.

A provider would select the appropriate records for printing based on the checklist received from the system—just like the other method of medical records collection described herein. The process is completely agnostic to the type of electronic medical records system used, as long as it runs on an operating system in which the medical records virtual printer driver can be installed.

By way of example only, as shown in FIG. 23, once the virtual printer has been selected a wizard page 2300 is displayed to guide the user through the processing system. On the first wizard page, a drop-down list of all the medical records print types (projects) 2302 for which there are authorized medical records requests queued will be displayed. Once the print type has been selected, a ‘Show Members’ button 2304 may be selected to show a list of members for which medical records are expected. After selecting the member, a list of available documents is displayed, for example as a new window.

This available documents wizard page 2400 shows a list of documents 2402 for the member/project with a checkbox 2404 next to each document. Any other selection indicator can be used. The provider simply selects or checks the appropriate boxes to indicate which documents to virtually print. Clicking ‘Next’ starts the ‘printing’ process.

This step transforms the print output into the appropriate format for further processing (e.g. multi-page TIFF, JPEG, PDF, or any other image file) and uploads it to a secure data center, already associated with the metadata, ready for automatic routing and further processing. Additional wizard pages may be displayed to indicate the status as shown in FIG. 25, and confirmation of delivery as shown in FIG. 26.

By installing this unique virtual printer driver, existing health plans, providers, etc., processed by this processing system will experience no substantive change (e.g. HEDIS client) or interruptions in work flow as no additional equipment would be required.

In some embodiments, the provider may want to virtually print to a third party or some other destination and not the collection system. In such embodiments, the receiving device must be specialized to receive such documents in a secure fashion. For example, the receiving device may require secure authentication for providers signed up on either the portal and/or the virtual printer driver install/configuration.

The overall architecture of the system and its components will move towards more autonomous components, each with a potential product value and extended uses, while enhancing the core processes and offerings. The major autonomous products/components will be: project data exchange, project data intake (data load), provider data intake, project data delivery, provider intelligence (database complemented by National Provider Database NPID), provider relations (Scheduling), medical records processing, medical records analysis—Abstraction services, potential add-ons, automation, project configuration and management (HEDIS, RAPS, RAC, etc.), including workflows spanning modules, health plan/client portal, and provider portal (upload, track, other services).

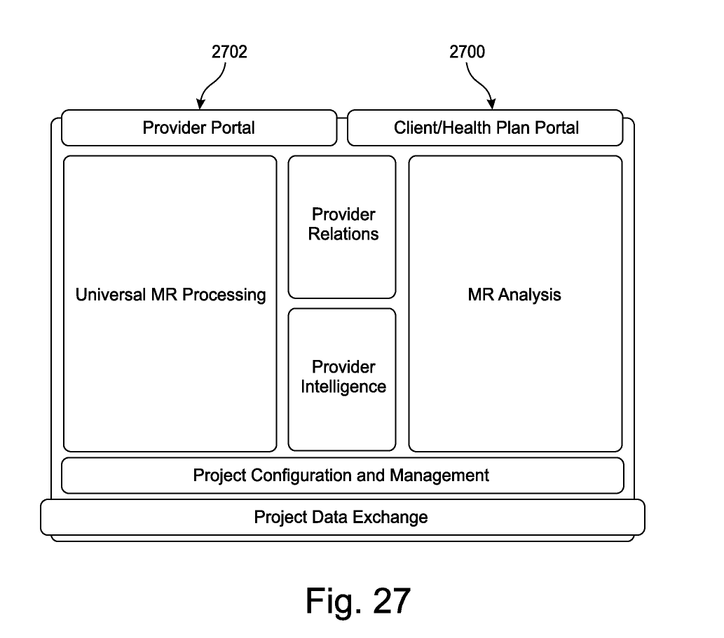

FIG. 27 shows the major steps and interactions between the backend services 2700 of the collection system and the secure virtual printer driver on the front-end 2702 at the provider's system. The core steps and architecture components for portal submission are the same.

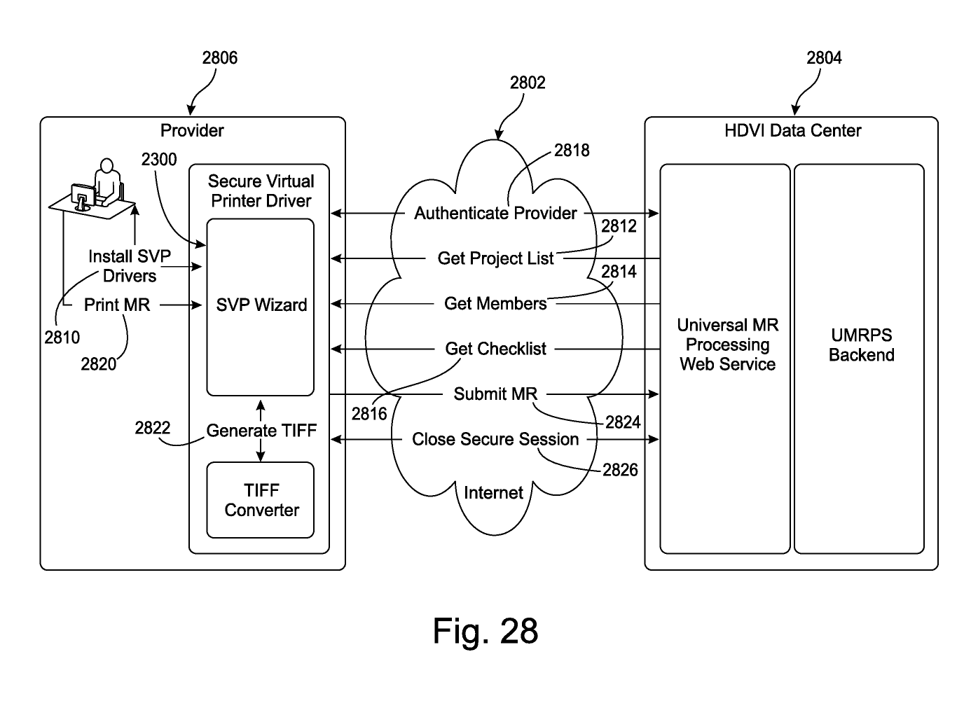

In one example as shown, in FIG. 28, the provider installs the secure virtual printer driver 2810 onto its computer, for example, from the provider portal or some other computer readable medium, to be used for submitting medical records to the system. The provider may configure the driver during which the identity of the provider is confirmed and a test connection to the processing system's secure backend services is established.

In some embodiments, a project list 2812, a members list 2814, and a checklist 2816 is sent to the provider to prompt the provider to print the medical records 2820 to the system. In some embodiments, a notification may be sent to the provider indicating that a request has been made. For example, an email may be sent to the provider indicating a request has been made. During the execution of the print job 2820, the project list 2812, the members list 2814, and/or the checklist 2816 may be provided as a selection for printing.

By way of example only, the provider may select the appropriate records for submission, the specific job request, the specific member, or some other identifying information associated with documents to be retrieved, then selects the print function 2820. Selecting the print function displays a print wizard 2300 to help navigate through the virtual printing process.

From the print wizard 2300, the user selects the secure virtual print printer option. The printer driver establishes a secure connection (session) 2802 with the backend system 2804 and authenticates 2818 the provider 2806. The driver may then load a list of active upload projects (types) 2812 and/or list of members 2814 into the wizard page for selection by the user.

Based on the user selection, the processing system may retrieve a list of members 2814, if it has not already done so, for which data has been requested for selection by the user. The processing system pulls the checklist 2816 for the items requested (e.g. lab results, progress notes), which the provider may have also previously received via PDF (or fax). The user then checks the appropriate boxes and starts the transmission.

A TIFF generator component 2822 is activated to convert the electronic medical record output into the appropriate TIFF format. The processing system submits 2824 the TIFF file along with the appropriate metadata to the backend system 2804 for further processing via the secure connection. The provider acknowledges completion and the processing system closes 2826 the connection to the backend 2804.

To ensure security, the backend service is hosted at a secure, SAS 70 Level II certified data center. In addition, time-outs with required log-in may be implemented after configurable idle-time (for example, 15 minutes) for portal uploads and provider portal. Thus, there is no activity on the portal for the predetermined idle-time, the system logs off and the user will be required to log-in again to restart the session.

Multiple levels of security, implementing best practices including SSL on the front-end, multiple firewalls, and a demilitarized zone or a perimeter network on the back-end may be utilized. Furthermore, role-based security with centralized provisioning/de-provisioning (extension of the system) can be implemented with extension of user accounts to providers (likely non-AD based).

To ensure functional integrity and efficiency, redundancy and appropriate hardware are fully implemented. In addition, redundant and extremely high bandwidth connectivity to the datacenter may be utilized. Furthermore, detailed audit trails for all activities may be maintained.

The system complies with all common regulatory and legal requirements including HIPAA, HITECH and patient privacy regulations and acknowledges understanding and adhering to all commonly expected standards by providers and regulatory bodies. As mentioned above, the data center is hosted in a SAS 70—Level II certified facility. Best practices implemented around these requirements will be diligently applied to the services in this new initiative.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A system for transmitting a medical record, comprising a server connected to a network, the server configured to receive requests from clients via the network, the server comprising:
a. at least one processor;
b. a database for storing medical records; and
c. a memory operatively coupled to the processor, the memory storing program instructions that when executed by the processor, causes the processor to:
i. receive a request for the medical record from a requester;
ii. relay the request to a provider;
iii. securely receive the medical record from the provider; and
iv. securely provide the medical record to the requester.

2. The system of claim 1, wherein receiving the request for the medical record from the requester, comprises authenticating the requester.

3. The system of claim 1, wherein securely receiving the medical record comprises:
a. authenticating the provider;
b. receiving an uploaded file from the provider; and
c. downloading the uploaded file to the database.

4. The system of claim 1, wherein securely receiving the medical record is actuated by receiving a virtual print request from the provider.

5. The system of claim 4, wherein receiving the virtual print request causes the system to print a file selected by the provider to the database.

6. The system of claim 1, wherein securely providing the medical record to the requester comprises providing a portal for the requester to login with a username and a password to access the medical record.

7. The system of claim 6, wherein securely providing a portal to the requester comprises sending an email containing a hyperlink to the portal.

8. A method for transmitting a medical record, comprising:
a. receiving a request for the medical record from a requester;
b. relaying the request to a provider;
c. securely receiving the medical record from the provider;
d. securely providing the medical record to the requester.

9. The method of claim 8, wherein receiving the request for the medical record comprises authenticating the requester.

10. The method of claim 8, wherein securely receiving the medical record comprises:
a. authenticating the provider;
b. receiving an uploaded file from the provider; and
c. downloading the uploaded file to the database.

11. The method of claim 8, further comprising receiving a virtual print request from the provider.

12. The method of claim 11, printing a file selected by the provider to the database.

13. The method of claim 8, wherein securely providing the medical record to the requester comprises providing a portal for the requester to login with a username and a password to access the medical record.

14. The method of claim 13, wherein securely providing a portal to the requester comprises sending an email containing a hyperlink to the portal.

15. A non-transitory computer readable medium storing instructions for causing at least one processor to perform a method for transmitting a medical record, the method comprising securely transmitting the medical record from a provider to a medical records collection system via an Internet connection in response to a request for the medical record from a requester.

16. The non-transitory computer readable medium of claim 15, wherein the method further comprises verifying a contact information and a national provider identification in real-time of the provider.

17. The non-transitory computer readable medium of claim 16, wherein the method further comprises transmitting computer information about a provider's computer to allow the system to authenticate the provider's computer.

18. The non-transitory computer readable medium of claim 17, wherein the method further comprises uploading the medical record to a medical record collection system.

19. The non-transitory computer readable medium of claim 17, wherein securely transmitting the medical record comprises virtually printing the medical record to the medical record collection system.

20. The non-transitory computer readable medium of claim 19, wherein the method further comprises providing a list of medical records for selection to print to the medical record collection system.
